(19) United States
(12) Patent Application Publication
(10) Pub. No.: US 2020/0157262 A1
(43) Pub. Date: May 21, 2020

(54) WIRE AND CABLE COATINGS

(71) Applicant: HONEYWELL INTERNATIONAL INC., MORRIS PLAINS, NJ (US)

(72) Inventors: ANDREW J. POSS, KENMORE, NY (US); DAVID NALEWAJEK, WEST SENECA, NY (US); RAJIV R. SINGH, GETZVILLE, NY (US); Veronika Viner, Morris Plains, NJ (US); Christophe Roger, Morris Plains, NJ (US)

(21) Appl. No.: 16/685,603

(22) Filed: Nov. 15, 2019

Related U.S. Application Data
(60) Provisional application No. 62/768,635, filed on Nov. 16, 2018.

(51) Int. Cl. C08F 214/18; C08F 214/06; C08F 216/08

(52) U.S. Cl. CPC C08F 214/182; C08F 214/186; C08F 214/06; C08F 2216/085; C08F 2800/10; C08F 2800/20; C08F 216/08

(57) ABSTRACT

The invention relates fluorocopolymer compositions for use in coating wires and cables, the use of the coating compositions, and to a substrate coated with the composition. The invention provides a fluorocopolymer that comprises hydrofluoroolefin monomers, vinyl ester monomers and/or halogen-containing monomers.

### CROSS REFERENCE TO RELATED APPLICATIONS

The present invention relates to and claims the priority benefit of U.S. Provisional application 62/768,635, filed on Nov. 16, 2018, which is incorporated herein by reference in its entirety.

### FIELD OF THE INVENTION

The present invention relates to hydrofluoroolefin copolymers for use in protective coatings for wire, cable and other electronic devices for the transmission of electrical/data signals, and in particular to high frequency transmission of electrical/data signals.

### BACKGROUND

Fluoropolymers exhibit unique properties that are not observed with other organic polymers. Fluoropolymers possess high thermal stability, chemical inertness, low flammability, low coefficient of friction, low surface energy, low dielectric constant, weather resistance, and gas barrier properties. These fluoropolymer properties enable their use in aerospace, automotive, construction, medical, pharmaceutical, and semiconductor industries. However, fluoropolymers have various drawbacks. As homopolymers, fluoropolymers are often highly crystalline, which induces poor solubility in common organic solvents and gives fluoropolymers relatively high melting points. Further, fluoropolymers do not adhere strongly to most surfaces and are known for their non-stick characteristics. As such, processing of fluoropolymers is difficult because of the lack of solubility in the common organic solvents that are typically used to apply polymers to various substrates, high melting points that result in application temperatures that may harm the substrate to which they are applied, and lack of adhesion to common substrates.

Several types of polymers have been used in coating compositions for wire, cables and other electronic/data transmission devices. Such coatings on serve varied purposes, such as to protect and/or insulate the underlying electronic/data transmission device. For example, a conductive wire is typically coated with an insulting material, such as, for example, polyimide, polytetrafluoroethylene (PTFE), polyvinyl chloride (PVC), a dielectric material, or another suitable material having insulative properties.

The dielectric constant of the material that is used for such coatings is important because it affects the speed and attenuation of the signals, and particulary the high frequency electrical signals, that are carried by such devices. In general, the electrical/data signal performance can be improved by decreasing the dielectric constant of the coating material. The dielectric constant is a complex number composed of the in-phase (or real component) called the permittivity, and the out-of-phase component (or imaginary) part called the loss. The ratio of the loss-to-permittivity is called the loss tangent. Lower permittivity and loss are highly desirable for electrical coating materials, especially for high frequency applications. In addition, however, other properties of the coating can be equally important. For example, the coating preferably also has acceptable flexibility and good adhesive strength. In addition, while coatings on data cables preferably have low dielectric constants and the other aforementioned properties, and cladding/coating on optical fibers are also low refractive index coatings. As the reasons for coating wires and cables become more and more diverse, applicants have come to appreciate that additional and more varied coatings need to be developed.

Thus, there is a need in the art for additional coatings for wires and cables that have a good thermal stability, a low dielectric constant, a low refractive index, and an improved processability. Preferred aspects of the present invention address and provide effective solutions to these and other needs.

### SUMMARY OF THE INVENTION

The present invention relates to fluorocopolymers for use in wire and cable coating compositions. The fluorocopolymer comprises monomers derived from (a) hydrofluoroolefins; and (b) one or more co-monomers selected from vinyl esters, one or more halogen-containing non-cyclic olefin co-monomers having from two (2) to six (6) carbon atoms (hereinafter for convenience referred to as “C2-C6”) different than monomer (a) and combinations of two or more of these. The present invention also provides coating compositions comprising the fluorocopolymer, substrates at least partially coated with the compositions, and methods for coating a substrate using the compositions, such as methods of coating a wire or cable using the compositions.

The fluorocopolymer can be formed by copolymerization of the monomers represented by (a) and (b):
(a) one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F; and
(b) one or more co-monomers selected from vinyl esters, one or more halogen-containing C2-C6 non-cyclic olefin co-monomers different than monomer (a), preferably one or more halogen-containing ethylene monomers, and combinations of two or more of these.

The fluoropolymers for wire coatings can provide the advantage, inter alia, of improved processability while providing improved thermal stability, low dielectric constant, and high refractive index.

The coatings comprising the fluorocopolymer are used in the coating of wires and cables. The coatings provide a high thermal stability, high flame resistance, and/or a high char value, and may be particularly suitable for platinum wire coating. Other uses include data cables, for which the present coatings provide a low dielectric constant. Still other uses include for optical fibers, for which the coatings described herein provide a low refractive index film.

### DETAILED DESCRIPTION OF THE INVENTION

As used herein, the term “copolymer” refers to polymers having two or more different monomer types that make up the polymer, and the term “fluorocopolymer” means copolymers in which at least one of the repeating units contains a fluorine and is based on a monomer that is a hydrofluoroolefin. The term “binary copolymer” refers to polymers having at least two different monomer types that make up the polymer, and the term “binary fluorocopolymer” means binary polymers in which one of the repeating units is based on a monomer that is a hydrofluoroolefin. The term “terpolymer” refers to polymers having at least three different monomer types that make up the polymer, and the term “terfluorocopolymer” means terpolymers in one of the repeating units is based on a monomer that is a hydrofluoroolefin. Thus, a terpolymer derived from monomers A, B and C has repeating units (-A-), (-B-) and (-C-), wherein at least one of these is the derived from hydrofluoroolefin monomer (a).

The fluorocopolymer comprises monomers derived from (a) hydrofluoroolefins according to Formula I as defined above, and (b) one or more co-monomers selected from the group consisting of vinyl esters, one or more halogen-containing C2-C6 non-cyclic olefin co-monomers different than monomer (a), including preferably halogen-containing ethylene-based co-monomers, and combinations of two or more of these.

### Hydrofluoroolefin

The fluorocopolymers used in the compositions of the present invention are prepared from at least two monomer types, and one or more of these monomers is a hydrofluoroolefin monomer. The hydrofluoroolefin monomers are represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F.

For the hydrofluoroolefins of formula I, at least one of R¹, R² or R³ is hydrogen. Preferred hydrofluoroolefins are selected from hydrofluoropropenes and hydrofluorobutenes.

The hydrofluoroolefin of formula I may be selected such that R¹ is F or CF₃. In embodiments of the invention, R¹ is F or CF₃ and R² and R³ are each H. Hydrofluoroolefin monomers having hydrogen for R² and R³ may have an increased reactivity in the polymerization reactions disclosed herein. Hydrofluoroolefin monomers for use in the present invention include one or more of 1234yf, 1234ze, 1233zd, 1233xf, 1336mzzm, 1336mcfq, 1225ye, 1225zc and 1224yd.

The hydrofluoroolefin monomers may be represented by the formula Ia:

(CF₃)(R₁ₐ)C═C(R^{2a})(R^{3a})

wherein:
R^{1a} is selected from the group consisting of H, F and CF₃;
R^{2a} is selected from the group consisting of H, F and CF₃, and preferably is selected from H and F; and
R^{1a} is selected from the group consisting of H and F.

The hydrofluoroolefin monomers may be represented by the formula Ib:

(CF₃)(R^{1b})C═C(R^{2b})(R^{3b})

wherein:
R^{1b} is selected from the group consisting of H and F;
R^{2b} is selected from the group consisting of H and F; and
R^{3b} is H.

The hydrofluoroolefin monomers are represented by the formula Ic:

(CF₃)(R^{1c})C═C(R^{2c})(R^{3c})

wherein:
R^{1c} is selected from the group consisting of H, F and Cl;
R^{2c} is CF₃; and
R^{3c} is selected from the group consisting of H and F.

The hydrofluoroolefin monomers may be represented by the formula Id:

(CF₃)(R^{1d})C═C(R^{2d})(R^{3d})

wherein:
R^{1d} is selected from the group consisting of H, F and Cl;
R^{2d} is selected from the group consisting of H, F and Cl; and
R^{3d} is H; wherein at least one of R^{1d} and R^{2d} is Cl.

The abbreviations for the hydrofluoroolefin monomers are provided below:

| | |
|---|---|
| CH₂═CFCF₃ | 1234yf |
| CFH═CHCF₃ | 1234ze |
| CF₃CH═CH₂ | 1243zf |
| ClCH═CHCF₃ | 1233zd |
| CF₃CCl═CH₂ | 1233xf |
| CF₃CF═CHF | 1225ye |
| CF₃CH═CF₂ | 1225zc |
| CF₃CF═CHCl | 1224yd |
| (CF₃)HC═CH(CF₃) | 1336mzzm |
| (CF₃)₂C═CH₂ | 1336mcfq |

Certain of the hydrofluoroolefins (1234ze, 1233zd, 1225ye, 1224yd, and 1336mzzm) may be present as the trans-isomer, the cis-isomer or a mixture of the two. For example, when HFO-1234ze is used as a monomer, it may be used as single isomer of HFO-1234ze (notwithstanding the presence of trace impurities of the other HFO-1234ze isomer), or a mixture of HFO-1234ze isomers.

In embodiments that use HFO-1234ze as the monomer, the monomer preferably comprises trans-1234ze. In such embodiments, the monomer comprises trans-1234ze in at least about 70% by weight based on the total 1234ze isomers. In other embodiments, the monomer comprises at least about 75%, 80%, 85%, 90% or 95% by weight based on the 1234ze isomers. In a further embodiment, the monomer comprises trans-1234ze in at least about 99% by weight based on the total 1234ze isomers. When the HFO monomer comprises 1234ze, the monomer composition may comprise about 70% trans-1234ze and about 30% cis-1234ze.

In embodiments that use HFO-1336mzzm as the monomer, the monomer may comprises the cis-1336mzzm isomer. In such embodiments, the monomer comprises cis-1336mzzm in at least about 70% by weight based on the total 1336mzzm isomers. In other embodiments, the monomer comprises at least about 75%, 80%, 85%, 90% or 95% of the cis-isomer by weight based on the 1336mzzm isomers. In a further embodiment, the monomer comprises cis-1336mzzm in at least about 99% by weight based on the total 1336mzzm isomers.

Alternatively, the HFO-1336mzzm monomer may comprises the trans-1336mzzm isomer. In such embodiments, the monomer comprises trans-1336mzzm in at least about 70% by weight based on the total 1336mzzm isomers. In other embodiments, the monomer comprises at least about 75%, 80%, 85%, 90% or 95% of the trans-isomer by weight based on the 1336mzzm isomers. In a further embodiment, the monomer comprises trans-1336mzzm in at least about 99% by weight based on the total 1336mzzm isomers.

In embodiments that use 1233zd as the monomer, the monomer may comprises the trans-1233zd isomer. In such embodiments, the monomer comprises trans-1233zd in at least about 70% by weight based on the total 1233zd isomers. In other embodiments, the monomer comprises at least about 75%, 80%, 85%, 90% or 95% of the trans-isomer by weight based on the 1233zd isomers. In a further embodiment, the monomer comprises trans-1233zd in at least about 99% by weight based on the total 1233zd isomers.

Alternatively, the 1233zd monomer may comprises the cis-1233zd isomer. In such embodiments, the monomer comprises cis-1233zd in at least about 70% by weight based on the total 1233zd isomers. In other embodiments, the monomer comprises at least about 75%, 80%, 85%, 90% or 95% of the cis-isomer by weight based on the 1233zd isomers. In a further embodiment, the monomer comprises cis-1233zd in at least about 99% by weight based on the total 1233zd isomers.

In embodiments that use 1225ye as the monomer, the monomer may comprises the trans-1225ye isomer. In such embodiments, the monomer comprises trans-1225ye in at least about 70% by weight based on the total 1225ye isomers. In other embodiments, the monomer comprises at least about 75%, 80%, 85%, 90% or 95% of the trans-isomer by weight based on the 1225ye isomers. In a further embodiment, the monomer comprises trans-1225ye in at least about 99% by weight based on the total 1225ye isomers.

Alternatively, the 1225ye monomer may comprises the cis-1225ye isomer. In such embodiments, the monomer comprises cis-1225ye in at least about 70% by weight based on the total 1225ye isomers. In other embodiments, the monomer comprises at least about 75%, 80%, 85%, 90% or 95% of the cis-isomer by weight based on the 1225ye isomers. In a further embodiment, the monomer comprises cis-1225ye in at least about 99% by weight based on the total 1225ye isomers.

In embodiments that use 1224yd as the monomer, the monomer may comprises the trans-1224yd isomer. In such embodiments, the monomer comprises trans-1224yd in at least about 70% by weight based on the total 1224yd isomers. In other embodiments, the monomer comprises at least about 75%, 80%, 85%, 90% or 95% of the trans-isomer by weight based on the 1224yd isomers. In a further embodiment, the monomer comprises trans-1224yd in at least about 99% by weight based on the total 1224yd isomers.

Alternatively, the 1224yd monomer may comprises the cis-1224yd isomer. In such embodiments, the monomer comprises cis-1224yd in at least about 70% by weight based on the total 1224yd isomers. In other embodiments, the monomer comprises at least about 75%, 80%, 85%, 90% or 95% of the cis-isomer by weight based on the 1224yd isomers. In a further embodiment, the monomer comprises cis-1224yd in at least about 99% by weight based on the total 1224yd isomers.

The hydrofluoroolefin monomers may comprise from about 40 to about 95 mol % of the monomers of the fluorocopolymer, or from about 40 to about 90 mol % of the monomers of the fluorocopolymer, or from about 55 to about 90 mol % of the monomers of the fluorocopolymer, or from about 60 to about 90 mol % of the monomers of the fluorocopolymer, or from about 55 to about 95 mol % of the monomers of the fluorocopolymer, or from about 70 to about 90 mol % of the monomers of the fluorocopolymer, or from about 70 to about 85 mol % of the monomers of the fluorocopolymer, or from about 75 to about 95 mol % of the monomers of the fluoro-copolymer, or from about 75 to about 90 mol % of the monomers of the fluoro-copolymer, or from about 80 to about 95 mol % of the monomers of the fluoro-copolymer.

Alternatively, the hydrofluoroolefin monomers may comprise from about 15 to about 85 mol % of the monomers of the fluorocopolymer, or from about 20 to about 75 mol % of the monomers of the fluorocopolymer, or from about 20 to about 75 mol % of the monomers of the fluorocopolymer, or from about 30 to about 65 mol % of the monomers of the fluorocopolymer, or from about 40 to about 55 mol % of the monomers of the fluoro-copolymer.

The hydrofluoroolefin monomers may comprise from about 5 to about 60 mol % of the monomers of the fluorocopolymer, or from about 5 to about 55 mol % of the monomers of the fluorocopolymer, or from about 10 to about 50 mol % of the monomers of the fluorocopolymer, or from about 5 to about 40 mol % of the monomers of the fluorocopolymer, or from about 10 to about 40 mol % of the monomers of the fluorocopolymer, or from about 5 to about 35 mol % of the monomers of the fluorocopolymer, or from about 10 to about 35 mol % of the monomers of the fluoro-copolymer.

### Co-Monomers

As described above, the fluorocopolymer also comprise one or more co-monomers selected from one or more vinyl esters, one or more halogen-containing C2-C6 non-cyclic olefin co-monomers different than monomer (a), and combinations of two or more of these.

### The Vinyl Esters

In the fluorocopolymer, the vinyl esters, particularly after hydrolysis, may assist in adhesion to the substrate and binding of aluminum oxide, magnesium hydroxide or the like to provide a durable, temperature resistant and fire-resistant wire coating. The vinyl esters may have the formula II:

(R⁵)₂C═C(R⁶)(O—C═O—R⁷)

wherein each R⁵ is independently selected from H and methyl, and is preferably H, R⁶ is selected from H and methyl, and R⁷ is selected from C₁ to C₆ branched or straight-chain alkyl, and R⁷ is preferably C₁ to C₃ alkyl.

The unsaturated ester can have the formula IIa:

H₂C═CH—O—(C═O)—R⁸

wherein each R⁸ is selected from C₁ to C₆ branched or straight-chain alkyl, and R⁸ is preferably C₁ to C₃ alkyl. Examples of vinyl ester co-monomers include vinyl acetate, vinyl propionate, vinyl butyrate and vinyl iso-butyrate.

The vinyl ester co-monomers may comprise less than about 60 mol % of the monomers in the fluorocopolymer, or from about 5 to about 60 mol % of the monomers of the fluorocopolymer, or from about 5 to about 45 mol % of the monomers of the fluorocopolymer, or from about 5 to about 40 mol % of the monomers of the fluorocopolymer, or from about 10 to about 40 mol % of the monomers of the fluoro-copolymer, or from about 5 to about 30 mol % of the monomers of the fluorocopolymer, or from about 10 to about 30 mol % of the monomers of the fluoro-copolymer, or from about 5 to about 25 mol % of the monomers of the fluoro-copolymer, or from about 10 to about 25 mol % of the monomers of the fluoro-copolymer.

### The Halogen-Containing C2-C6 Non-Cyclic Olefin Comonomers

The halogen-containing C2-C6 non-cyclic olefin co-monomers, when present, is preferably comprised of C2-C6 non-cyclic olefin co-monomers having fluorine and/or chlorine substituents. A non-exhaustive list of examples of C2-C6 non-cyclic olefin co-monomers includes the following: 1, 1-dichloroethene (also known as vinylidene chloride); 1, 1-dichloroethene in both its cis and trans forms (also known as cis- and trans-DCE); chlorotrifluoroethylene; tetrafluoroethene; 1,1-dichlorotetrafluoropropene; octofluoro-2-butene; 1,2,3,3,4,4-hexafluoro-1-butene; 2,3,3,4,4,4-hexafluoro-1-butene; 1,1,1,4,4,4,-hexafluoro-2-butene; 1,2,3,3,3-pentafluorpropene; 1,1,3,3,3-pentafluorpropene; 1,3,3,3-tetrafluoroprop-1-ene; 1,2-dichloroethylene; 1-chloro-3,3,3-trifluoropropene; 2,3-dichloro-1,1,1,4,4,4-hexafluoro-2-butene; 2-chloro-1,1,1,4,4,4-hexafluor-2-butene; (e)-1,1,1,3-tetrafluoro-2-butene; 4,4,4-trifluoro-1-butene; (z)-1,1,1,3-trifluoro-1-butene; 1,4-dichlroo-hexafluoro-2-butene; 2,4,4,4-tetrafluoro-1-butene; (e/z)-2-chloroheptafluoro-2-butene; 1,1,1,2,4,4,4-heptafluoro-2-butene; 4-chloro-1,1,1,2-trifluoro-1-butene; 2-chloro-1,1,1,3-tetrafluoro-2-butene; 1,1,1-trifluoro-2-butene; 2,3,3,4,4,4,-hexafluoro-1-butene; (e)-2-chloro-1,1,1,4,4,4-hexafluoro-2-butene; (z)-2-chloro-1,1,1,4,4,4-hexafluoro-2-butene; octofluoro-1-butene; 4-fluoro-1-butene; trans-1,4-dichloro-2-butene; 3-chloro-1-butene; 2,3-dichlorohexafluorobutene-2; hexafluoroisobutene; 1,1-difluorobutene; 3,3,4,4,4-pentafluorobutene-1; 1,1,4,4,4-pentafluorobutene-1; 3,3,4,4,5,5,5-heptafluoro-1-pentene; 2H-nonafluoro-2-pentene; (e)-2H, 3H-octafluoro-2-pentene; 2H,3H-otacofuoro-2-pentene; cis-2H-nonafluoro-2-pentene; perfluoropentene-2; 4,4,5,5,6,6,6-heptafluoro-2-hexane; 2,4-dichloro-1,1,1,6,6,6-hexafluoro-2-hexene; 2-chloro-3,3,4,4,5,5,6,6,6-nonafluoro-1-hexene; perfluorohexene-2; perfluorohexene-1; and 1H, 1H, 2H-perfluorohexene.

In preferred embodiments the C2-C6 non-cyclic olefin co-monomer comprises, or consists essentially of, or consists of a C2 halogen containing co-monomer according to the formula:

R¹R²C═CR¹R²
wherein R¹ and R² are each independently selected from Cl, H, or F, provided that at least one Cl or F is present on the molecule. As will be appreciated, therefore, preferred C2-C6 non-cyclic olefin co-monomer of the present invention include all fluoroethylene, all chloroethylene monomers and all chlorofluoroethylene monomers. For example, the halogen-containing comonomer may comprise an ethylene moiety having at least one fluorine substituent, and optionally one or more hydrogen(s) and one or more chlorine substituent(s), or it may include an ethylene moiety having at least one chlorine substituent and optionally one or more hydrogen(s) and one or more fluorine substituent(s). One or more halogen-containing ethylene-based co-monomers as described by the formula in this paragraph could be, by way of non-exhaustive examples, vinyl fluoride (VF), vinylidene fluoride (VDF), trifluoroethylene (TrFE), tetrafluoroethylene (TFE), chlorotrifluoroethylene (CTFE), vinyl chloride (VC), cis- and/or trans-DCE, and combinations of two or more of these.

The halogen-containing C2-C6 non-cyclic olefin co-monomer in preferred embodiments has the formula:

H2C═CR¹R²
wherein R¹ is selected from Cl, H, or F and R₂ is Cl or F. One or more halogen-containing ethylene-based co-monomers as described by the formula in this paragraph could be, by way of non-exhaustive examples, vinyl fluoride (C₂H₃F), vinylidene fluoride (CH₂═CF₂), vinyl chloride (C₂H₃Cl), vinylidene chloride (CH₂═CCl₂), and combinations of two or more of these.

The halogen-containing C2-C6 non-cyclic olefin co-monomer, and preferably the halogen containing ethylene-based co-monomer(s) according to either of the formulas as described in the preceeding paragraphs, may be present in an amount of from about 40 to about 95 mol % of the monomers of the fluorocopolymer, or from about 50 to about 95 mol % of the monomers of the fluorocopolymer, or from about 55 to about 90 mol % of the monomers of the fluorocopolymer, or from about 60 to about 95 mol % of the monomers of the fluorocopolymer, or from about 70 to about 95 mol % of the monomers of the fluorocopolymer.

Alternatively, the halogen-containing C2-C6 non-cyclic olefin co-monomer, and preferably the halogen containing ethylene-based co-monomer(s) according to either of the formulas as described in the preceeding paragraph(s) may be present in an amount of from about 10 to about 85 mol % of the monomers of the fluorocopolymer, or from about 20 to about 75 mol % of the monomers of the fluorocopolymer, or from about 20 to about 75 mol % of the monomers of the fluorocopolymer, or from about 30 to about 65 mol % of the monomers of the fluorocopolymer, or from about 40 to about 55 mol % of the monomers of the fluoro-copolymer.

Alternatively, the halogen-containing C2-C6 non-cyclic olefin co-monomer, and preferably the halogen containing ethylene-based co-monomer(s) according to either of the formulas as described in the preceeding paragraphs(s) may be present in an amount of from about 5 to about 60 mol % of the monomers of the fluorocopolymer, or from about 5 to about 55 mol % of the monomers of the fluorocopolymer, or from about 10 to about 50 mol % of the monomers of the fluorocopolymer, or from about 5 to about 40 mol % of the monomers of the fluorocopolymer, or from about 10 to about 40 mol % of the monomers of the fluorocopolymer, or from about 5 to about 35 mol % of the monomers of the fluorocopolymer, or from about 10 to about 35 mol % of the monomers of the fluoro-copolymer.

### Fluorocopolymer

The fluorocopolymer can be formed by copolymerization of the monomers comprising (a) and (b):
(a) about 40-95 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters, C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a) and (b):
(a) about 40-95 mol % of one or more hydrofluoroolefin represented by the formula Ia:

(CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F; and
(b) about 5-60 mol % of one or more co-monomers selected from vinyl esters, or C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a) and (b):
(a) about 40-95 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F;
R^{3b} is H; and
R^{3a} is selected from the group consisting of H and F; and
(b) about 5-60 mol % of one or more co-monomers selected from vinyl esters, C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a) and (b):
(a) about 40-95 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters, C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a) and (b):
(a) about 40-95 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters, a C2 halogen containing co-monomer according to the formula:

R¹R²C═CR¹R²
wherein R¹ and R² are each independently selected from Cl, H, or F, provided that at least one Cl or F is present on the molecule, and combinations of two or more of these.

The fluorocopolymer can be formed by copolymerization of the monomers comprising (a) and (b):
(a) about 40-95 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2a} is CF₃; and
R^{3c} is selected from the group consisting of H and F;
(b) about 5-60 mol % of one or more co-monomers selected from vinyl esters, a C2 halogen containing co-monomer according to the formula:

H₂C═CR¹R²
wherein R¹ and R² are each independently selected from Cl, H, or F, provided that at least one Cl or F is present on the molecule, and combinations of two or more of these.

The fluorocopolymer can be formed by copolymerization of the monomers comprising (a) and (b):

(a) about 40-95 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl; and
   (b) about 5-60 mol % of one or more co-monomers selected from vinyl esters, C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a) and (b):

(a) about 40-95 mol % of one or more hydrofluoroolefin represented by the formula Id:

(CF₃)(R^{1d})C═C(R^{2d})(R^{3d})

wherein:
R^{1d} is selected from the group consisting of H, F and Cl;
R^{2d} is selected from the group consisting of H, F and Cl; and
R^{3d} is H; wherein at least one of R^{1d} and R^{2d} is Cl; and
(b) about 5-60 mol % of one or more co-monomers selected from vinyl esters, a C2 halogen containing co-monomer according to the formula:

R¹R²C═CR¹R²
wherein R¹ and R² are each independently selected from Cl, H, or F, provided that at least one Cl or F is present on the molecule, and combinations of two or more of these.

The fluorocopolymer can be formed by copolymerization of the monomers comprising (a) and (b):

(a) about 40-95 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl; and
   (b) about 5-60 mol % of one or more co-monomers selected from vinyl esters, a C2 halogen containing co-monomer according to the formula:

H₂C═CR¹R²
wherein R¹ and R² are each independently selected from Cl, H, or F, provided that at least one Cl or F is present on the molecule, and combinations of two or more of these.

The present invention provides the fluorocopolymers as listed in Table 1.

TABLE 1
compositions of fluorocopolymers

| monomer | | Mol % ranges | | |
|---|---|---|---|---|
| HFO | co-monomer | preferred | more preferred | most preferred |
| Formula I | vinyl ester(s) | 40-95% Form. I | 55-95% Form. I | 60-90% Form. I |
| (CF₃)(R¹)C═C(R²)(R³) | | 5-60% vinyl | 5-45% vinyl | 10-40% vinyl |
| | | ester | ester | ester |
| Formula I | Formula II | 40-95% Form. I | 55-95% Form. I | 60-90% Form. I |
| (CF₃)(R¹)C═C(R²)(R³) | (R⁵)₂C═C(R⁶)(O—C═O—R⁷) | 5-60% Form. II | 5-45% Form. II | 10-40% Form. II |
| Formula I | Formula IIa | 40-95% Form. I | 55-95% Form. I | 60-90% Form. I |
| (CF₃)(R¹)C═C(R²)(R³) | H₂C═CH—O—(C═O)—R⁸ | 5-60% Form. | 5-45% Form. | 10-40% Form. |
| | | IIa | IIa | IIa |
| Formula I | Halogen-containing | 10-95% Form. I, | 10-90% Form I, | |
| (CF₃)(R¹)C═C(R²)(R³) | monomer | 5-90% Halogen- | 10-90% | |
| | | containing | Halogen- | |
| | | monomer | containing | |
| | | | monomer | |
| Formula Ia | Halogen-containing | 10-95% Form. I, | 10-90% Form I, | 60-90% Form. Ia |
| (CF₃)(R^{1a})C═C(R^{2a})(R^{3a}) | monomer | 5-90% Halogen- | 10-90% | 10-40% vinyl |
| | | containing | Halogen- | ester |
| | | monomer | containing | |
| | | | monomer | |
| Formula Ia | Formula II | 40-95% Form. | 55-95% Form. | 60-90% Form. Ia |
| (CF₃)(R^{1a})C═C(Ra²)(R^{3a}) | (R⁵)₂C═C(R⁶)(O—C═O—R⁷) | Ia | Ia | 10-40% Form. II |
| | | 5-60% Form. II | 5-45% Form. II | |
| Formula Ia | Formula IIa | 40-95% Form. | 55-95% Form. | 60-90% Form. Ia |
| (CF₃)(R^{1a})C═C(R^{2a})(R^{3a}) | H₂C═CH—O—(C═O)—R⁸ | Ia | Ia | 10-40% Form. |
| | | 5-60% Form. | 5-45% Form. | IIa |
| | | IIa | IIa | |
| Formula Ia | Halogen-containing | 10-95% Form. | 10-90% Form Ia, | |
| (CF₃)(R^{1a})C═C(R^{2a})(R^{3a}) | monomer | Ia, | 10-90% | |
| | | 5-90% Halogen- | Halogen- | |
| | | containing | containing | |
| | | monomer | monomer | |
| Formula Ib | vinyl ester(s) | 40-95% Form. | 55-95% Form. | 60-90% Form. Ib |
| (CF₃)(R^{1b})C═C(R^{2b})(R^{3b}) | | Ib | Ib | 10-40% vinyl |
| | | 5-60% vinyl | 5-45% vinyl | ester |
| | | ester | ester | |
| Formula Ib | Formula II | 40-95% Form. | 55-95% Form. | 60-90% Form. Ib |
| (CF₃)(R^{1b})C═C(R^{2b})(R^{3b}) | (R⁵)₂C═C(R⁶)(O—C═O—R⁷) | Ib | Ib | 10-40% Form. II |
| | | 5-60% Form. II | 5-45% Form. II | |
| Formula Ib | Formula IIa | 40-95% Form. | 55-95% Form. | 60-90% Form. Ib |
| (CF₃)(R^{1b})C═C(R^{2b})(R^{3b}) | H₂C═CH—O—(C═O)—R⁸ | Ib | Ib | 10-40% Form. |
| | | 5-60% Form. | 5-45% Form. | IIa |
| | | IIa | IIa | |
| Formula Ib | Halogen-containing | 10-95% Form. | 10-90% Form Ib, | |
| (CF₃)(R^{1b})C═C(R^{2b})(R^{3b}) | monomer | Ib, | 10-90% | |
| | | 5-90% Halogen- | Halogen- | |
| | | containing | containing | |
| | | monomer | monomer | |
| Formula Ic | vinyl ester(s) | 40-95% Form. | 55-95% Form. | 60-90% Form. Ic |
| (CF₃)(R^{1c})C═C(R^{2c})(R^{3c}) | | Ic | Ic | 10-40% vinyl |
| | | 5-60% vinyl | 5-45% vinyl | ester |
| | | ester | ester | |
| Formula Ic | Formula II | 40-95% Form. | 55-95% Form. | 60-90% Form. Ic |
| (CF₃)(R^{1c})C═C(R^{2c})(R^{3c}) | (R⁵)₂C═C(R⁶)(O—C═O—R⁷) | Ic | Ic | 10-40% Form. II |
| | | 5-60% Form. II | 5-45% Form. II | |
| Formula Ic | Formula IIa | 40-95% Form. | 55-95% Form. | 60-90% Form. Ic |
| (CF₃)(R^{1c})C═C(R^{2c})(R^{3c}) | H₂C═CH—O—(C═O)—R⁸ | Ic | Ic | 10-40% Form. |
| | | 5-60% Form. | 5-45% Form. | IIa |
| | | IIa | IIa | |
| Formula Ic | Halogen-containing | 10-95% Form. | 10-90% Form Ic, | |
| (CF₃)(R^{1c})C═C(R^{2c})(R^{3c}) | monomer | Ic, | 10-90% | |
| | | 5-90% Halogen- | Halogen- | |
| | | containing | containing | |
| | | monomer | monomer | |
| Formula Id | vinyl ester(s) | 40-95% Form. | 55-95% Form. | 60-90% Form. Id |
| (CF₃)(R^{1d})C═C(R^{2d})(R^{3d}) | | Id | Id | 10-40% vinyl |
| | | 5-60% vinyl | 5-45% vinyl | ester |
| | | ester | ester | |
| Formula Id | Formula II | 40-95% Form. | 55-95% Form. Id | 60-90% Form. Id |
| (CF₃)(R^{1d})C═C(R^{2d})(R^{3d}) | (R⁵)₂C═C(R⁶)(O—C═O—R⁷) | Id | 5-45% Form. II | 10-40% Form. II |
| | | 5-60% Form. II | | |
| Formula Id | Formula IIa | 40-95% Form. | 55-95% Form. | 60-90% Form. Id |
| (CF₃)(R^{1d})C═C(R^{2d})(R^{3d}) | H₂C═CH—O—(C═O)—R⁸ | Id | Id | 10-40% Form. |
| | | 5-60% Form. | 5-45% Form. | IIa |
| | | IIa | IIa | |
| Formula Id | Halogen-containing | 10-95% Form. | 10-90% Form Id, | |
| (CF₃)(R^{1d})C═C(R^{2d})(R^{3d}) | monomer | Id, | 10-90% | |
| | | 5-90% Halogen- | Halogen- | |
| | | containing | containing | |
| | | monomer | monomer | |
| 1234yf | vinyl ester(s) | 40-95% 1234yf | 55-95% 1234yf | 60-90% 1234yf |
| | | 5-60% vinyl | 5-45% vinyl | 10-40% vinyl |
| | | ester | ester | ester |
| 1234yf | Formula II | 40-95% 1234yf | 55-95% 1234yf | 60-90% 1234yf |
| | (R⁵)₂C═C(R⁶)(O—C═O—R⁷) | 5-60% Form. II | 5-45% Form. II | 10-40% Form. II |
| 1234yf | Formula IIa | 40-95% 1234yf | 55-95% 1234yf | 60-90% 1234yf |
| | H₂C═CH—O—(C═O)—R⁸ | 5-60% Form. | 5-45% Form. | 10-40% Form. |
| | | IIa | IIa | IIa |
| 1234yf | Halogen-containing | 10-95% 1234yf, | 10-90% 1234yf, | |
| | monomer | 5-90% Halogen- | 10-90% | |
| | | containing | Halogen- | |
| | | monomer | containing | |
| | | | monomer | |
| 1234ze | vinyl ester(s) | 40-95% 1234ze | 55-95% 1234ze | 60-90% 1234ze |
| | | 5-60% vinyl | 5-45% vinyl | 10-40% vinyl |
| | | ester | ester | ester |
| 1234ze | Formula II | 40-95% 1234ze | 55-95% 1234ze | 60-90% 1234ze |
| | (R⁵)₂C═C(R⁶)(O—C═O—R⁷) | 5-60% Form. II | 5-45% Form. II | 10-40% Form. II |
| 1234ze | Formula IIa | 40-95% 1234ze | 55-95% 1234ze | 60-90% 1234ze |
| | H₂C═CH—O—(C═O)—R⁸ | 5-60% Form. | 5-45% Form. | 10-40% Form. |
| | | IIa | IIa | IIa |
| 1234ze | Halogen-containing | 10-95% 1234ze, | 10-90% 1234ze, | |
| | monomer | 5-90% Halogen- | 10-90% | |
| | | containing | Halogen- | |
| | | monomer | containing | |
| | | | monomer | |
| trans-1234ze | vinyl ester(s) | 40-95% trans- | 55-95% trans- | 60-90% trans- |
| | | 1234ze | 1234ze | 1234ze |
| | | 5-60% vinyl | 5-45% vinyl | 10-40% vinyl |
| | | ester | ester | ester |
| trans-1234ze | Formula II | 40-95% trans- | 55-95% trans- | 60-90% trans- |
| | (R⁵)₂C═C(R⁶)(O—C═O—R⁷) | 1234ze | 1234ze | 1234ze |
| | | 5-60% Form. II | 5-45% Form. II | 10-40% Form. II |
| trans-1234ze | Formula IIa | 40-95% trans- | 55-95% trans- | 60-90% trans- |
| | H₂C═CH—O—(C═O)—R⁸ | 1234ze | 1234ze | 1234ze |
| | | 5-60% Form. | 5-45% Form. | 10-40% Form. |
| | | IIa | IIa | IIa |
| Trans 1234ze | Halogen-containing | 10-95% trans | 10-90% trans | |
| | monomer | 1234ze, | 1234ze, | |
| | | 5-90% Halogen- | 10-90% | |
| | | containing | Halogen- | |
| | | monomer | containing | |
| | | | monomer | |
| 1243zf | vinyl ester(s) | 40-95% 1243zf | 55-95% 1243zf | 60-90% 1243zf |
| | | 5-60% vinyl | 5-45% vinyl | 10-40% vinyl |
| | | ester | ester | ester |
| 1243zf | Formula II | 40-95% 1234yf | 55-95% 1234yf | 60-90% 1234yf |
| | (R⁵)₂C═C(R⁶)(O—C═O—R⁷) | 5-60% Form. II | 5-45% Form. II | 10-40% Form. II |
| 1243zf | Formula IIa | 40-95% 1234yf | 55-95% 1234yf | 60-90% 1234yf |
| | H₂C═CH—O—(C═O)—R⁸ | 5-60% Form. | 5-45% Form. | 10-40% Form. |
| | | IIa | IIa | IIa |
| 1243zf | Halogen-containing | 10-95% 1243zf, | 10-90% 1243zf, | |
| | monomer | 5-90% Halogen- | 10-90% | |
| | | containing | Halogen- | |
| | | monomer | containing | |
| | | | monomer | |
| 1225ye | vinyl ester(s) | 40-95% 1225ye | 55-95% 1225ye | 60-90% 1225ye |
| | | 5-60% vinyl | 5-45% vinyl | 10-40% vinyl |
| | | ester | ester | ester |
| 1225ye | Formula II | 40-95% 1225ye | 55-95% 1225ye | 60-90% 1225ye |
| | (R⁵)₂C═C(R⁶)(O—C═O—R⁷) | 5-60% Form. II | 5-45% Form. II | 10-40% Form. II |
| 1225ye | Formula IIa | 40-95% 1225ye | 55-95% 1225ye | 60-90% 1225ye |
| | H₂C═CH—O—(C═O)—R⁸ | 5-60% Form. | 5-45% Form. | 10-40% Form. |
| | | IIa | IIa | IIa |
| 1225ye | Halogen-containing | 10-95% 1225ye, | 10-90% 1225ye, | |
| | monomer | 5-90% Halogen- | 10-90% | |
| | | containing | Halogen- | |
| | | monomer | containing | |
| | | | monomer | |
| 1336mzzm | vinyl ester(s) | 40-95% | 55-95% | 60-90% |
| | | 1336mzzm | 1336mzzm | 1336mzzm |
| | | 5-60% vinyl | 5-45% vinyl | 10-40% vinyl |
| | | ester | ester | ester |
| 1336mzzm | Formula II | 40-95% | 55-95% | 60-90% |
| | (R⁵)₂C═C(R⁶)(O—C═O—R⁷) | 1336mzzm | 1336mzzm | 1336mzzm |
| | | 5-60% Form. II | 5-45% Form. II | 10-40% Form. II |
| 1336mzzm | Formula IIa | 40-95% | 55-95% | 60-90% |
| | H₂C═CH—O—(C═O)—R⁸ | 1336mzzm | 1336mzzm | 1336mzzm |
| | | 5-60% Form. | 5-45% Form. | 10-40% Form. |
| | | IIa | IIa | IIa |
| 1336mzzm | Halogen-containing | 10-95% | 10-90% | |
| | monomer | 1336mzzm, | 1336mzzm, | |
| | | 5-90% Halogen- | 10-90% | |
| | | containing | Halogen- | |
| | | monomer | containing | |
| | | | monomer | |
| cis-1336mzzm | vinyl ester(s) | 40-95% cis- | 55-95% cis- | 60-90% cis- |
| | | 1336mzzm | 1336mzzm | 1336mzzm |
| | | 5-60% vinyl | 5-45% vinyl | 10-40% vinyl |
| | | ester | ester | ester |
| cis-1336mzzm | Formula II | 40-95% cis- | 55-95% cis- | 60-90% cis- |
| | (R⁵)₂C═C(R⁶)(O—C═O—R⁷) | 1336mzzm | 1336mzzm | 1336mzzm |
| | | 5-60% Form. II | 5-45% Form. II | 10-40% Form. II |
| cis-1336mzzm | Formula IIa | 40-95% cis- | 55-95% cis- | 60-90% cis- |
| | H₂C═CH—O—(C═O)—R⁸ | 1336mzzm | 1336mzzm | 1336mzzm |
| | | 5-60% Form. | 5-45% Form. | 10-40% Form. |
| | | IIa | IIa | IIa |
| Cis-1336mzzm | Halogen-containing | 10-95% cis- | 10-90% cis- | |
| | monomer | 1336mzzm, | 1336mzzm, | |
| | | 5-90% Halogen- | 10-90% | |
| | | containing | Halogen- | |
| | | monomer | containing | |
| | | | monomer | |
| 1336mcfq | vinyl ester(s) | 40-95% | 55-95% | 60-90% |
| | | 1336mcfq | 1336mcfq | 1336mcfq |
| | | 5-60% vinyl | 5-45% vinyl | 10-40% vinyl |
| | | ester | ester | ester |
| 1336mcfq | Formula II | 40-95% | 55-95% | 60-90% |
| | (R⁵)₂C═C(R⁶)(O—C═O—R⁷) | 1336mcfq | 1336mcfq | 1336mcfq |
| | | 5-60% Form. II | 5-45% Form. II | 10-40% Form. II |
| 1336mcfq | Formula IIa | 40-95% | 55-95% | 60-90% |
| | H₂C═CH—O—(C═O)—R⁸ | 1336mcfq | 1336mcfq | 1336mcfq |
| | | 5-60% Form. | 5-45% Form. | 10-40% Form. |
| | | IIa | IIa | IIa |
| 1336mcfq | Halogen-containing | 10-95% | 10-90% | |
| | monomer | 1336mcfq, | 1336mcfq, | |
| | | 5-90% Halogen- | 10-90% | |
| | | containing | Halogen- | |
| | | monomer | containing | |
| | | | monomer | |
| 1233zd | vinyl ester(s) | 40-95% 1233zd | 55-95% 1233zd | 60-90% 1233zd |
| | | 5-60% vinyl | 5-45% vinyl | 10-40% vinyl |
| | | ester | ester | ester |
| 1233zd | Formula II | 40-95% 1233zd | 55-95% 1233zd | 60-90% 1233zd |
| | (R⁵)₂C═C(R⁶)(O—C═O—R⁷) | 5-60% Form. II | 5-45% Form. II | 10-40% Form. II |
| 1233zd | Formula IIa | 40-95% 1233zd | 55-95% 1233zd | 60-90% 1233zd |
| | H₂C═CH—O—(C═O)—R⁸ | 5-60% Form. | 5-45% Form. | 10-40% Form. |
| | | IIa | IIa | IIa |
| 1233zd | Halogen-containing | 10-95% 1233zd, | 10-90% 1233zd, | |
| | monomer | 5-90% Halogen- | 10-90% | |
| | | containing | Halogen- | |
| | | monomer | containing | |
| | | | monomer | |
| 1233xf | vinyl ester(s) | 40-95% 1233xf | 55-95% 1233xf | 60-90% 1233xf |
| | | 5-60% vinyl | 5-45% vinyl | 10-40% vinyl |
| | | ester | ester | ester |
| 1233xf | Formula II | 40-95% 1233xf | 55-95% 1233xf | 60-90% 1233xf |
| | (R⁵)₂C═C(R⁶)(O—C═O—R⁷) | 5-60% Form. II | 5-45% Form. II | 10-40% Form. II |
| 1233xf | Formula IIa | 40-95% 1233xf | 55-95% 1233xf | 60-90% 1233xf |
| | H₂C═CH—O—(C═O)—R⁸ | 5-60% Form. | 5-45% Form. | 10-40% Form. |
| | | IIa | IIa | IIa |
| 1233xf | Halogen-containing | 10-95% 1233xf, | 10-90% 1233xf, | |
| | monomer | 5-90% Halogen- | 10-90% | |
| | | containing | Halogen- | |
| | | monomer | containing | |
| | | | monomer | |
| 1224yd | vinyl ester(s) | 40-95% 1224yd | 55-95% 1224yd | 60-90% 1224yd |
| | | 5-60% vinyl | 5-45% vinyl | 10-40% vinyl |
| | | ester | ester | ester |
| 1224yd | Formula II | 40-95% 1224yd | 55-95% 1224yd | 60-90% 1224yd |
| | (R⁵)₂C═C(R⁶)(O—C═O—R⁷) | 5-60% Form. II | 5-45% Form. II | 10-40% Form. II |
| 1224yd | Formula IIa | 40-95% 1224yd | 55-95% 1224yd | 60-90% 1224yd |
| | H₂C═CH—O—(C═O)—R⁸ | 5-60% Form. | 5-45% Form. | 10-40% Form. |
| | | IIa | IIa | IIa |
| 1224yd | Halogen-containing | 10-95% 1224yd, | 10-90% 1224yd, | |
| | monomer | 5-90% Halogen- | 10-90% | |
| | | containing | Halogen- | |
| | | monomer | containing | |
| | | | monomer | |

The present invention further provides the fluorocopolymers as listed in Table 2.

TABLE 2
compositions of HFO and co-monomers

| | | Mol % ranges | | |
|---|---|---|---|---|
| | | preferred | more preferred | most preferred |
| | | mol % HFO | mol % HFO | mol % HFO |
| Monomer | | mol % co- | mol % co- | mol % co- |
| HFO | co-monomer | monomer | monomer | monomer |
| 1234yf | vinyl acetate | 40-95% | 55-95% | 60-90% |
| | | 5-60% | 5-45% | 10-40% |
| 1234yf | vinyl propionate | 40-95% | 55-95% | 60-90% |
| | | 5-60% | 5-45% | 10-40% |
| 1234yf | vinyl butyrate | 40-95% | 55-95% | 60-90% |
| | | 5-60% | 5-45% | 10-40% |
| 1234yf | VDF | 10-95% | 10-90% | |
| | | 5-90% | 10-90% | |
| 1234yf | Vinyl chloride | 10-95% | 10-90% | |
| | | 5-90% | 10-90% | |
| 1234ze | vinyl acetate | 40-95% | 55-95% | 60-90% |
| | | 5-60% | 5-45% | 10-40% |
| 1234ze | vinyl propionate | 40-95% | 55-95% | 60-90% |
| | | 5-60% | 5-45% | 10-40% |
| 1234ze | vinyl butyrate | 40-95% | 55-95% | 60-90% |
| | | 5-60% | 5-45% | 10-40% |
| 1234ze | VDF | 10-95% | 10-90% | |
| | | 5-90% | 10-90% | |
| 1234ze | Vinyl chloride | 10-95% | 10-90% | |
| | | 5-90% | 10-90% | |
| Trans- | VDF | 10-95% | 10-90% | |
| 1234ze | | 5-90% | 10-90% | |
| Trans- | Vinyl chloride | 10-95% | 10-90% | |
| 1234ze | | 5-90% | 10-90% | |
| trans- | vinyl acetate | 40-95% | 55-95% | 60-90% |
| 1234ze | | 5-60% | 5-45% | 10-40% |
| trans- | vinyl propionate | 40-95% | 55-95% | 60-90% |
| 1234ze | | 5-60% | 5-45% | 10-40% |
| trans- | vinyl butyrate | 40-95% | 55-95% | 60-90% |
| 1234ze | | 5-60% | 5-45% | 10-40% |
| 1243zf | vinyl acetate | 40-95% | 55-95% | 60-90% |
| | | 5-60% | 5-45% | 10-40% |
| 1243zf | vinyl propionate | 40-95% | 55-95% | 60-90% |
| | | 5-60% | 5-45% | 10-40% |
| 1243zf | vinyl butyrate | 40-95% | 55-95% | 60-90% |
| | | 5-60% | 5-45% | 10-40% |
| 1243zf | VDF | 10-95% | 10-90% | |
| | | 5-90% | 10-90% | |
| 1243zf | Vinyl chloride | 10-95% | 10-90% | |
| | | 5-90% | 10-90% | |
| 1225ye | vinyl acetate | 40-95% | 55-95% | 60-90% |
| | | 5-60% | 5-45% | 10-40% |
| 1225ye | vinyl propionate | 40-95% | 55-95% | 60-90% |
| | | 5-60% | 5-45% | 10-40% |
| 1225ye | vinyl butyrate | 40-95% | 55-95% | 60-90% |
| | | 5-60% | 5-45% | 10-40% |
| 1225ye | VDF | 10-95% | 10-90% | |
| | | 5-90% | 10-90% | |
| 1225ye | Vinyl chloride | 10-95% | 10-90% | |
| | | 5-90% | 10-90% | |
| 1336mzzm | vinyl acetate | 40-95% | 55-95% | 60-90% |
| | | 5-60% | 5-45% | 10-40% |
| 1336mzzm | vinyl propionate | 40-95% | 55-95% | 60-90% |
| | | 5-60% | 5-45% | 10-40% |
| 1336mzzm | vinyl butyrate | 40-95% | 55-95% | 60-90% |
| | | 5-60% | 5-45% | 10-40% |
| 1336mzzm | VDF | 10-95% | 10-90% | |
| | | 5-90% | 10-90% | |
| 1336mzzm | Vinyl chloride | 10-95% | 10-90% | |
| | | 5-90% | 10-90% | |
| Cis- | VDF | 10-95% | 10-90% | |
| 1336mzzm | | 5-90% | 10-90% | |
| Cis- | Vinyl chloride | 10-95% | 10-90% | |
| 1336mzzm | | 5-90% | 10-90% | |
| cis- | vinyl acetate | 40-95% | 55-95% | 60-90% |
| 1336mzzm | | 5-60% | 5-45% | 10-40% |
| cis- | vinyl propionate | 40-95% | 55-95% | 60-90% |
| 1336mzzm | | 5-60% | 5-45% | 10-40% |
| cis- | vinyl butyrate | 40-95% | 55-95% | 60-90% |
| 1336mzzm | | 5-60% | 5-45% | 10-40% |
| 1336mcfq | vinyl acetate | 40-95% | 55-95% | 60-90% |
| | | 5-60% | 5-45% | 10-40% |
| 1336mcfq | vinyl propionate | 40-95% | 55-95% | 60-90% |
| | | 5-60% | 5-45% | 10-40% |
| 1336mcfq | vinyl butyrate | 40-95% | 55-95% | 60-90% |
| | | 5-60% | 5-45% | 10-40% |
| 1336mcfq | VDF | 10-95% | 10-90% | |
| | | 5-90% | 10-90% | |
| 1336mcfq | Vinyl chloride | 10-95% | 10-90% | |
| | | 5-90% | 10-90% | |
| 1233zd | vinyl acetate | 40-95% | 55-95% | 60-90% |
| | | 5-60% | 5-45% | 10-40% |
| 1233zd | vinyl propionate | 40-95% | 55-95% | 60-90% |
| | | 5-60% | 5-45% | 10-40% |
| 1233zd | vinyl butyrate | 40-95% | 55-95% | 60-90% |
| | | 5-60% | 5-45% | 10-40% |
| 1233zd | VDF | 10-95% | 10-90% | |
| | | 5-90% | 10-90% | |
| 1233zd | Vinyl chloride | 10-95% | 10-90% | |
| | | 5-90% | 10-90% | |
| 1233xf | vinyl acetate | 40-95% | 55-95% | 60-90% |
| | | 5-60% | 5-45% | 10-40% |
| 1233xf | vinyl propionate | 40-95% | 55-95% | 60-90% |
| | | 5-60% | 5-45% | 10-40% |
| 1233xf | vinyl butyrate | 40-95% | 55-95% | 60-90% |
| | | 5-60% | 5-45% | 10-40% |
| 1233xf | VDF | 10-95% | 10-90% | |
| | | 5-90% | 10-90% | |
| 1233xf | Vinyl chloride | 10-95% | 10-90% | |
| | | 5-90% | 10-90% | |
| 1224yd | vinyl acetate | 40-95% | 55-95% | 60-90% |
| | | 5-60% | 5-45% | 10-40% |
| 1224yd | vinyl propionate | 40-95% | 55-95% | 60-90% |
| | | 5-60% | 5-45% | 10-40% |
| 1224yd | vinyl butyrate | 40-95% | 55-95% | 60-90% |
| | | 5-60% | 5-45% | 10-40% |
| 1224yd | VDF | 10-95% | 10-90% | |
| | | 5-90% | 10-90% | |
| 1224yd | Vinyl chloride | 10-95% | 10-90% | |
| | | 5-90% | 10-90% | |

### Ternary Copolymers

The fluorocopolymer used in the coatings of the present invention can be formed by copolymerization of the monomers comprising (a), (b) and (c):
(a) about 40-95 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 5-55 mol % of one or more C2-C6 non-cyclic olefin co-monomer, and preferably the halogen containing ethylene-based co-monomer(s) according to either of the formulas as described in the preceeding paragraphs.

The fluorocopolymer used in the coatings of the present invention can be formed by copolymerization of the monomers comprising (a), (b) and (c):
(a) about 40-95 mol % of one or more hydrofluoroolefin represented by the formula I:

(CF₃)(R¹)C═C(R²)(R³)
wherein:
   R¹ is selected from the group consisting of H, F, Cl and CF₃;
   R² is selected from the group consisting of H, F, Cl and CF₃, and preferably is selected from H and F; and
   R³ is selected from the group consisting of H and F;
(b) about 5-60 mol % of one or more co-monomers selected from vinyl esters; and
(c) about 5-55 mol % of one or more monomers havingthe formula:

R¹R²C═CR¹R²
wherein R¹ and R² are each independently selected from Cl, H, or F, provided that at least one Cl or F is present on the molecule.

The fluorocopolymer used in the coatings of the present invention can be formed by copolymerization of the monomers comprising (a), (b) and (c):
(a) about 40-95 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 5-55 mol % of one or more monomers can having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 40-95 mol % of one or more hydrofluoroolefin represented by the formula Ia:

(CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F;
(b) about 5-60 mol % of one or more co-monomers selected from vinyl esters; and
(c) about 5-55 mol % of one or more monomers can having the formula:

R¹R²C═CR¹R²
wherein R¹ and R² are each independently selected from Cl, H, or F, provided that at least one Cl or F is present on the molecule

The fluorocopolymer can be formed by copolymerization of the monomers comprising (a), (b) and (c):
(a) about 40-95 mol % of one or more hydrofluoroolefin represented by the formula Ia:

(CF₃)(R^{1a})C═C(R^{2a})(R^{3a})Ia
wherein:
R^{1a} is selected from the group consisting of H, F and CF₃;
   R^{2a} is selected from the group consisting of H, F and CF₃, and preferably is selected from H and F; and
R^{3a} is selected from the group consisting of H and F;
(b) about 5-60 mol % of one or more co-monomers selected from vinyl esters; and (c) about 5-55 mol % of one or more monomers having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 40-95 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F;
R^{3b} is H; and
R^{3a} is selected from the group consisting of H and F;
(b) about 5-60 mol % of one or more co-monomers selected from vinyl esters; and
(c) about 5-55 mol % of one or more fluoroethylenes.

The fluorocopolymer can be formed by copolymerization of the monomers comprising (a), (b) and (c):
(a) about 40-95 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 5-55 mol % of one or more fluoroethylenes.

The fluorocopolymer can be formed by copolymerization of the monomers comprising (a), (b) and (c):
(a) about 40-95 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl;
(b) about 5-60 mol % of one or more co-monomers selected from vinyl esters; and
(c) about 5-55 mol % of one or more fluoroethylenes, chloroethylenes, chlorofluoroethylene and combinations of these.

The present invention provides the fluorocopolymers as listed in Table 3.

TABLE 3
compositions of terfluorocopolymers

| monomer | | | Mol % ranges | | |
|---|---|---|---|---|---|
| | first co- | second co- | | more | most |
| hydrofluoroolefin | monomer | monomer | preferred | preferred | preferred |
| Formula I | vinyl ester(s) | fluoroethylenes | 40-90% | 55-90% | 60-90% |
| (CF₃)(R¹)C═C(R²)(R³) | | | Form. I | Form. I | Form. I |
| | | | 5-60% 1st | 5-40% 1st | 5-20% 1^{st} |
| | | | 5-55% 2^{nd} | 5-40% 2^{nd} | 5-35% 2^{nd} |
| Formula I | Formula II | fluoroethylenes | 40-90% | 55-90% | 60-90% |
| | (R⁵)₂C═C(R⁶)(O—C═O—R⁷) | | Form. I | Form. I | Form. I |
| | | | 5-60% 1st | 5-40% 1st | 5-20% 1^{st} |
| | | | 5-55% 2^{nd} | 5-40% 2^{nd} | 5-35% 2^{nd} |
| Formula I | Formula IIa | fluoroethylenes | 40-90% | 55-90% | 60-90% |
| | H₂C═CH—O—(C═O)—R⁸ | | Form. I | Form. I | Form. I |
| | | | 5-60% 1st | 5-40% 1st | 5-20% 1^{st} |
| | | | 5-55% 2^{nd} | 5-40% 2^{nd} | 5-35% 2^{nd} |
| Formula Ia | vinyl ester(s) | fluoroethylenes | 40-90% | 55-90% | 60-90% |
| (CF₃)(R^{1a})C═CH₂ | | | Form. Ia | Form. Ia | Form. Ia |
| | | | 5-60% 1st | 5-40% 1st | 5-20% 1^{st} |
| | | | 5-55% 2^{nd} | 5-40% 2^{nd} | 5-35% 2^{nd} |
| Formula Ia | Formula II | fluoroethylenes | 40-90% | 55-90% | 60-90% |
| | (R⁵)₂C═C(R⁶)(O—C═O—R⁷) | | Form. Ia | Form. Ia | Form. Ia |
| | | | 5-60% 1st | 5-40% 1st | 5-20% 1^{st} |
| | | | 5-55% 2^{nd} | 5-40% 2^{nd} | 5-35% 2^{nd} |
| Formula Ia | Formula IIa | fluoroethylenes | 40-90% | 55-90% | 60-90% |
| | H₂C═CH—O—(C═O)—R⁸ | | Form. Ia | Form. Ia | Form. Ia |
| | | | 5-60% 1st | 5-40% 1st | 5-20% 1^{st} |
| | | | 5-55% 2^{nd} | 5-40% 2^{nd} | 5-35% 2^{nd} |
| Formula Ib | vinyl ester(s) | fluoroethylenes | 40-90% | 55-90% | 60-90% |
| (CF₃)(R^{1b})C═C(R^{2b})(R^{3b}) | | | Form. Ib | Form. Ib | Form. Ib |
| | | | 5-60% 1st | 5-40% 1st | 5-20% 1^{st} |
| | | | 5-55% 2^{nd} | 5-40% 2^{nd} | 5-35% 2^{nd} |
| Formula Ib | Formula II | fluoroethylenes | 40-90% | 55-90% | 60-90% |
| | (R⁵)₂C═C(R⁶)(O—C═O—R⁷) | | Form. Ib | Form. Ib | Form. Ib |
| | | | 5-60% 1st | 5-40% 1st | 5-20% 1^{st} |
| | | | 5-55% 2^{nd} | 5-40% 2^{nd} | 5-35% 2^{nd} |
| Formula Ib | Formula IIa | fluoroethylenes | 40-90% | 55-90% | 60-90% |
| | H₂C═CH—O—(C═O)—R⁸ | | Form. Ib | Form. Ib | Form. Ib |
| | | | 5-60% 1st | 5-40% 1st | 5-20% 1^{st} |
| | | | 5-55% 2^{nd} | 5-40% 2^{nd} | 5-35% 2^{nd} |
| Formula Ic | vinyl ester(s) | fluoroethylenes | 40-90% | 55-90% | 60-90% |
| (CF₃)(R^{1c})C═C(R^{2c})(R^{3c}) | | | Form. Ic | Form. Ic | Form. Ic |
| | | | 5-60% 1st | 5-40% 1st | 5-20% 1^{st} |
| | | | 5-55% 2^{nd} | 5-40% 2^{nd} | 5-35% 2^{nd} |
| Formula Ic | Formula II | fluoroethylenes | 40-90% | 55-90% | 60-90% |
| | (R⁵)₂C═C(R⁶)(O—C═O—R⁷) | | Form. Ic | Form. Ic | Form. Ic |
| | | | 5-60% 1st | 5-40% 1st | 5-20% 1^{st} |
| | | | 5-55% 2^{nd} | 5-40% 2^{nd} | 5-35% 2^{nd} |
| Formula Ic | Formula IIa | fluoroethylenes | 40-90% | 55-90% | 60-90% |
| | H₂C═CH—O—(C═O)—R⁸ | | Form. Ic | Form. Ic | Form. Ic |
| | | | 5-60% 1st | 5-40% 1st | 5-20% 1^{st} |
| | | | 5-55% 2^{nd} | 5-40% 2^{nd} | 5-35% 2^{nd} |
| Formula Id | vinyl ester(s) | fluoroethylenes | 40-90% | 55-90% | 60-90% |
| (CF₃)(R^{1d})C═C(R^{2d})(R^{3d}) | | | Form. Id | Form. Id | Form. Id |
| | | | 5-60% 1st | 5-40% 1st | 5-20% 1^{st} |
| | | | 5-55% 2^{nd} | 5-40% 2^{nd} | 5-35% 2^{nd} |
| Formula Id | Formula II | fluoroethylenes | 40-90% | 55-90% | 60-90% |
| | (R⁵)₂C═C(R⁶)(O—C═O—R⁷) | | Form. Id | Form. Id | Form. Id |
| | | | 5-60% 1st | 5-40% 1st | 5-20% 1^{st} |
| | | | 5-55% 2^{nd} | 5-40% 2^{nd} | 5-35% 2^{nd} |
| Formula Id | Formula IIa | fluoroethylenes | 40-90% | 55-90% | 60-90% |
| | H₂C═CH—O—(C═O)—R⁸ | | Form. Id | Form. Id | Form. Id |
| | | | 5-60% 1st | 5-40% 1st | 5-20% 1^{st} |
| | | | 5-55% 2^{nd} | 5-40% 2^{nd} | 5-35% 2^{nd} |
| 1234yf | vinyl ester(s) | fluoroethylenes | 40-90% | 55-90% | 60-90% |
| | | | 1234yf | 1234yf | 1234yf |
| | | | 5-60% 1st | 5-40% 1st | 5-20% 1^{st} |
| | | | 5-55% 2^{nd} | 5-40% 2^{nd} | 5-35% 2^{nd} |
| 1234yf | Formula II | fluoroethylenes | 40-90% | 55-90% | 60-90% |
| | (R⁵)₂C═C(R⁶)(O—C═O—R⁷) | | 1234yf | 1234yf | 1234yf |
| | | | 5-60% 1st | 5-40% 1st | 5-20% 1^{st} |
| | | | 5-55% 2^{nd} | 5-40% 2^{nd} | 5-35% 2^{nd} |
| 1234yf | Formula IIa | fluoroethylenes | 40-90% | 55-90% | 60-90% |
| | H₂C═CH—O—(C═O)—R⁸ | | 1234yf | 1234yf | 1234yf |
| | | | 5-60% 1st | 5-40% 1st | 5-20% 1^{st} |
| | | | 5-55% 2^{nd} | 5-40% 2^{nd} | 5-35% 2^{nd} |
| 1234ze | vinyl ester(s) | fluoroethylenes | 40-90% | 55-90% | 60-90% |
| | | | 1234ze | 1234ze | 1234ze |
| | | | 5-60% 1st | 5-40% 1st | 5-20% 1^{st} |
| | | | 5-55% 2^{nd} | 5-40% 2^{nd} | 5-35% 2^{nd} |
| 1234ze | Formula II | fluoroethylenes | 40-90% | 55-90% | 60-90% |
| | (R⁵)₂C═C(R⁶)(O—C═O—R⁷) | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | Formula IIa | fluoroethylenes | 40-90% | 55-90% | 60-90% |
| | H₂C═CH—O—(C═O)—R⁸ | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl ester(s) | fluoroethylenes | 40-90% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | Formula II | fluoroethylenes | 40-90% | 55-90% | 60-90% |
| | (R⁵)₂C═C(R⁶)(O—C═O—R⁷) | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | Formula IIa | fluoroethylenes | 40-90% | 55-90% | 60-90% |
| | H₂C═CH—O—(C═O)—R⁸ | | trans-1234ze | trans-1234ze | 5-20% 1^{st} |
| | | | 5-60% 1st | 5-40% 1st | 5-35% 2^{nd} |
| | | | 5-55% 2nd | 5-40% 2^{nd} | |
| 1243zf | vinyl ester(s) | fluoroethylenes | 40-90% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | Formula II | fluoroethylenes | 40-90% | 55-90% | 60-90% |
| | (R⁵)₂C═C(R⁶)(O—C═O—R⁷) | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | Formula IIa | fluoroethylenes | 40-90% | 55-90% | 60-90% |
| | H₂C═CH—O—(C═O)—R⁸ | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1225ye | vinyl ester(s) | fluoroethylenes | 40-90% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | Formula II | fluoroethylenes | 40-90% | 55-90% | 60-90% |
| | (R⁵)₂C═C(R⁶)(O—C═O—R⁷) | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | Formula IIa | fluoroethylenes | 40-90% | 55-90% | 60-90% |
| | H₂C═CH—O—(C═O)—R⁸ | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl ester(s) | fluoroethylenes | 40-90% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | Formula II | fluoroethylenes | 40-90% | 55-90% | 60-90% |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | Formula IIa | fluoroethylenes | 40-90% | 55-90% | 60-90% |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl ester(s) | fluoroethylenes | 40-90% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | Formula II | fluoroethylenes | 40-90% cis- | 55-90% cis- | 60-90% cis- |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | Formula IIa | fluoroethylenes | 40-90% cis- | 55-90% cis- | 60-90% cis- |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl ester(s) | fluoroethylenes | 40-90% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | Formula II | fluoroethylenes | 40-90% | 55-90% | 60-90% |
| | (R⁵)₂C═C(R⁶)(O—C═O—R⁷) | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | Formula IIa | fluoroethylenes | 40-90% | 55-90% | 60-90% |
| | H₂C═CH—O—(C═O)—R⁸ | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1233zd | vinyl ester(s) | fluoroethylenes | 40-90% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | Formula II | fluoroethylenes | 40-90% | 55-90% | 60-90% |
| | (R⁵)₂C═C(R⁶)(O—C═O—R⁷) | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | Formula IIa | fluoroethylenes | 40-90% | 55-90% | 60-90% |
| | H₂C═CH—O—(C═O)—R⁸ | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233xf | vinyl ester(s) | fluoroethylenes | 40-90% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | Formula II | fluoroethylenes | 40-90% | 55-90% | 60-90% |
| | (R⁵)₂C═C(R⁶)(O—C═O—R⁷) | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | Formula IIa | fluoroethylenes | 40-90% | 55-90% | 60-90% |
| | H₂C═CH—O—(C═O)—R⁸ | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1224yd | vinyl ester(s) | fluoroethylenes | 40-90% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | Formula II | fluoroethylenes | 40-90% | 55-90% | 60-90% |
| | (R⁵)₂C═C(R⁶)(O—C═O—R⁷) | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | Formula IIa | fluoroethylenes | 40-90% | 55-90% | 60-90% |
| | H₂C═CH—O—(C═O)—R⁸ | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |

The present invention further provides the fluorocopolymers as listed in Table 4.

TABLE 4
monomer combinations for terpolymers

| monomer | | | Mol % ranges | | |
|---|---|---|---|---|---|
| | first co- | second co- | | more | most |
| hydrofluoroolefin | monomer | monomer | preferred | preferred | preferred |
| Formula I | vinyl acetate | VF | 40-90% | 55-90% | 60-90% |
| (CF₃)(R¹)C═C(R²)(R³) | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl | VF | 40-90% | 55-90% | 60-90% |
| | propionate | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl butyrate | VF | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl acetate | VDF | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl | VDF | 40-90% | 55-90% | 60-90% |
| | propionate | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl butyrate | VDF | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl acetate | TrFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl | TrFE | 40-90% | 55-90% | 60-90% |
| | propionate | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl butyrate | TrFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl acetate | TFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl | TFE | 40-90% | 55-90% | 60-90% |
| | propionate | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl butyrate | TFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl acetate | CTFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl | CTFE | 40-90% | 55-90% | 60-90% |
| | propionate | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula I | vinyl butyrate | CTFE | 40-90% | 55-90% | 60-90% |
| | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl acetate | VF | 40-90% | 55-90% | 60-90% |
| (CF₃)(R^{1a})C═C(R^{2a})(R^{3a}) | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl | VF | 40-90% | 55-90% | 60-90% |
| | propionate | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl butyrate | VF | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl acetate | VDF | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl | VDF | 40-90% | 55-90% | 60-90% |
| | propionate | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl butyrate | VDF | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl acetate | TrFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl | TrFE | 40-90% | 55-90% | 60-90% |
| | propionate | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl butyrate | TrFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl acetate | TFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl | TFE | 40-90% | 55-90% | 60-90% |
| | propionate | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl butyrate | TFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl acetate | CTFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl | CTFE | 40-90% | 55-90% | 60-90% |
| | propionate | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ia | vinyl butyrate | CTFE | 40-90% | 55-90% | 60-90% |
| | | | Form. Ia | Form. Ia | Form. Ia |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl acetate | VF | 40-90% | 55-90% | 60-90% |
| (CF₃)(R^{1b})C═C(R^{2b})(R^{3b}) | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl | VF | 40-90% | 55-90% | 60-90% |
| | propionate | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl butyrate | VF | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl acetate | VDF | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl | VDF | 40-90% | 55-90% | 60-90% |
| | propionate | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl butyrate | VDF | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl acetate | TrFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl | TrFE | 40-90% | 55-90% | 60-90% |
| | propionate | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl butyrate | TrFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl acetate | TFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl | TFE | 40-90% | 55-90% | 60-90% |
| | propionate | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl butyrate | TFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl acetate | CTFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl | CTFE | 40-90% | 55-90% | 60-90% |
| | propionate | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ib | vinyl butyrate | CTFE | 40-90% | 55-90% | 60-90% |
| | | | Form. Ib | Form. Ib | Form. Ib |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl acetate | VF | 40-90% | 55-90% | 60-90% |
| (CF₃)(R^{1c})C═C(R^{2c})(R^{3c}) | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl | VF | 40-90% | 55-90% | 60-90% |
| | propionate | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl butyrate | VF | 40-90% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl acetate | VDF | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl | VDF | 40-95% | 55-90% | 60-90% |
| | propionate | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl butyrate | VDF | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl acetate | TrFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl | TrFE | 40-95% | 55-90% | 60-90% |
| | propionate | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl butyrate | TrFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl acetate | TFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl | TFE | 40-95% | 55-90% | 60-90% |
| | propionate | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl butyrate | TFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl acetate | CTFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl | CTFE | 40-95% | 55-90% | 60-90% |
| | propionate | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Ic | vinyl butyrate | CTFE | 40-95% | 55-90% | 60-90% |
| | | | Form. Ic | Form. Ic | Form. Ic |
| | | | 5-60% 1st | 5-40% 1st | 5-20% 1^{st} |
| | | | 5-55% 2nd | 5-40% 2^{nd} | 5-35% 2^{nd} |
| Formula Id | vinyl acetate | VF | 40-95% | 55-90% | 60-90% |
| (CF₃)(R^{1d})C═C(R^{2d})(R^{3d}) | | | Form. I | Form. I | Form. I |
| | | | 5-60% 1st | 5-40% 1st | 5-20% 1^{st} |
| | | | 5-55% 2nd | 5-40% 2^{nd} | 5-35% 2^{nd} |
| Formula Id | vinyl | VF | 40-95% | 55-90% | 60-90% |
| | propionate | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl butyrate | VF | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl acetate | VDF | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl | VDF | 40-95% | 55-90% | 60-90% |
| | propionate | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl butyrate | VDF | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl acetate | TrFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl | TrFE | 40-95% | 55-90% | 60-90% |
| | propionate | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl butyrate | TrFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl acetate | TFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl | TFE | 40-95% | 55-90% | 60-90% |
| | propionate | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl butyrate | TFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl acetate | CTFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl | CTFE | 40-95% | 55-90% | 60-90% |
| | propionate | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| Formula Id | vinyl butyrate | CTFE | 40-95% | 55-90% | 60-90% |
| | | | Form. Id | Form. Id | Form. Id |
| | | | 5-60% 1st | 5-40% 1st | 5-20% 1^{st} |
| | | | 5-55% 2nd | 5-40% 2^{nd} | 5-35% 2^{nd} |
| 1234yf | vinyl acetate | VF | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl | VF | 40-95% | 55-90% | 60-90% |
| | propionate | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl butyrate | VF | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl acetate | VDF | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl | VDF | 40-95% | 55-90% | 60-90% |
| | propionate | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl butyrate | VDF | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl acetate | TrFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl | TrFE | 40-95% | 55-90% | 60-90% |
| | propionate | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl butyrate | TrFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl acetate | TFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl | TFE | 40-95% | 55-90% | 60-90% |
| | propionate | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl butyrate | TFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl acetate | CTFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl | CTFE | 40-95% | 55-90% | 60-90% |
| | propionate | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234yf | vinyl butyrate | CTFE | 40-95% | 55-90% | 60-90% |
| | | | 1234yf | 1234yf | 1234yf |
| | | | 5-60% 1st | 5-40% 1st | 5-20% 1^{st} |
| | | | 5-55% 2nd | 5-40% 2^{nd} | 5-35% 2^{nd} |
| 1234ze | vinyl acetate | VF | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl | VF | 40-95% | 55-90% | 60-90% |
| | propionate | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl butyrate | VF | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl acetate | VDF | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl | VDF | 40-95% | 55-90% | 60-90% |
| | propionate | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl butyrate | VDF | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl acetate | TrFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl | TrFE | 40-95% | 55-90% | 60-90% |
| | propionate | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl butyrate | TrFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl acetate | TFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl | TFE | 40-95% | 55-90% | 60-90% |
| | propionate | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl butyrate | TFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl acetate | CTFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl | CTFE | 40-95% | 55-90% | 60-90% |
| | propionate | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| 1234ze | vinyl butyrate | CTFE | 40-95% | 55-90% | 60-90% |
| | | | 1234ze | 1234ze | 1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl acetate | VF | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl | VF | 40-95% | 55-90% | 60-90% |
| | propionate | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl butyrate | VF | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl acetate | VDF | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl | VDF | 40-95% | 55-90% | 60-90% |
| | propionate | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl butyrate | VDF | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl acetate | TrFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl | TrFE | 40-95% | 55-90% | 60-90% |
| | propionate | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl butyrate | TrFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl acetate | TFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl | TFE | 40-95% | 55-90% | 60-90% |
| | propionate | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl butyrate | TFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl acetate | CTFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl | CTFE | 40-95% | 55-90% | 60-90% |
| | propionate | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| trans-1234ze | vinyl butyrate | CTFE | 40-95% | 55-90% | 60-90% |
| | | | trans-1234ze | trans-1234ze | trans-1234ze |
| | | | 5-60% 1st | 5-40% 1st | 5-20% 1^{st} |
| | | | 5-55% 2nd | 5-40% 2^{nd} | 5-35% 2^{nd} |
| 1243zf | vinyl acetate | VF | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl | VF | 40-95% | 55-90% | 60-90% |
| | propionate | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl butyrate | VF | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl acetate | VDF | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl | VDF | 40-95% | 55-90% | 60-90% |
| | propionate | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl butyrate | VDF | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl acetate | TrFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl | TrFE | 40-95% | 55-90% | 60-90% |
| | propionate | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl butyrate | TrFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl acetate | TFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl | TFE | 40-95% | 55-90% | 60-90% |
| | propionate | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl butyrate | TFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl acetate | CTFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl | CTFE | 40-95% | 55-90% | 60-90% |
| | propionate | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1243zf | vinyl butyrate | CTFE | 40-95% | 55-90% | 60-90% |
| | | | 1243zf | 1243zf | 1243zf |
| | | | 5-60% 1st | 5-40% 1st | 5-20% 1^{st} |
| | | | 5-55% 2nd | 5-40% 2^{nd} | 5-35% 2^{nd} |
| 1225ye | vinyl acetate | VF | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl | VF | 40-95% | 55-90% | 60-90% |
| | propionate | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl butyrate | VF | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl acetate | VDF | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl | VDF | 40-95% | 55-90% | 60-90% |
| | propionate | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl butyrate | VDF | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl acetate | TrFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl | TrFE | 40-95% | 55-90% | 60-90% |
| | propionate | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl butyrate | TrFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl acetate | TFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl | TFE | 40-95% | 55-90% | 60-90% |
| | propionate | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl butyrate | TFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl acetate | CTFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl | CTFE | 40-95% | 55-90% | 60-90% |
| | propionate | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1225ye | vinyl butyrate | CTFE | 40-95% | 55-90% | 60-90% |
| | | | 1225ye | 1225ye | 1225ye |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl acetate | VF | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl | VF | 40-95% | 55-90% | 60-90% |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl butyrate | VF | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl acetate | VDF | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl | VDF | 40-95% | 55-90% | 60-90% |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl butyrate | VDF | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl acetate | TrFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl | TrFE | 40-95% | 55-90% | 60-90% |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl butyrate | TrFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl acetate | TFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl | TFE | 40-95% | 55-90% | 60-90% |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl butyrate | TFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl acetate | CTFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl | CTFE | 40-95% | 55-90% | 60-90% |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mzzm | vinyl butyrate | CTFE | 40-95% | 55-90% | 60-90% |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl acetate | VF | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl | VF | 40-95% cis- | 55-90% cis- | 60-90% cis- |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl butyrate | VF | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl acetate | VDF | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl | VDF | 40-95% cis- | 55-90% cis- | 60-90% cis- |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl butyrate | VDF | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl acetate | TrFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl | TrFE | 40-95% cis- | 55-90% cis- | 60-90% cis- |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl butyrate | TrFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl acetate | TFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl | TFE | 40-95% cis- | 55-90% cis- | 60-90% cis- |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl butyrate | TFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl acetate | CTFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl | CTFE | 40-95% cis- | 55-90% cis- | 60-90% cis- |
| | propionate | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| cis-1336mzzm | vinyl butyrate | CTFE | 40-95% cis- | 55-90% cis- | 60-90% cis- |
| | | | 1336mzzm | 1336mzzm | 1336mzzm |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl acetate | VF | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl | VF | 40-95% | 55-90% | 60-90% |
| | propionate | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl butyrate | VF | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl acetate | VDF | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl | VDF | 40-95% | 55-90% | 60-90% |
| | propionate | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl butyrate | VDF | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl acetate | TrFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl | TrFE | 40-95% | 55-90% | 60-90% |
| | propionate | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl butyrate | TrFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl acetate | TFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl | TFE | 40-95% | 55-90% | 60-90% |
| | propionate | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl butyrate | TFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl acetate | CTFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl | CTFE | 40-95% | 55-90% | 60-90% |
| | propionate | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1336mcfq | vinyl butyrate | CTFE | 40-95% | 55-90% | 60-90% |
| | | | 1336mcfq | 1336mcfq | 1336mcfq |
| | | | 5-60% 1st | 5-40% 1st | 5-20% 1^{st} |
| | | | 5-55% 2nd | 5-40% 2^{nd} | 5-35% 2^{nd} |
| 1233zd | vinyl acetate | VF | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl | VF | 40-95% | 55-90% | 60-90% |
| | propionate | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl butyrate | VF | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl acetate | VDF | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl | VDF | 40-95% | 55-90% | 60-90% |
| | propionate | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl butyrate | VDF | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl acetate | TrFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl | TrFE | 40-95% | 55-90% | 60-90% |
| | propionate | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl butyrate | TrFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl acetate | TFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl | TFE | 40-95% | 55-90% | 60-90% |
| | propionate | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl butyrate | TFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl acetate | CTFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl | CTFE | 40-95% | 55-90% | 60-90% |
| | propionate | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233zd | vinyl butyrate | CTFE | 40-95% | 55-90% | 60-90% |
| | | | 1233zd | 1233zd | 1233zd |
| | | | 5-60% 1st | 5-40% 1st | 5-20% 1^{st} |
| | | | 5-55% 2nd | 5-40% 2^{nd} | 5-35% 2^{nd} |
| 1233xf | vinyl acetate | VF | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl | VF | 40-95% | 55-90% | 60-90% |
| | propionate | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl butyrate | VF | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl acetate | VDF | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl | VDF | 40-95% | 55-90% | 60-90% |
| | propionate | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl butyrate | VDF | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl acetate | TrFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl | TrFE | 40-95% | 55-90% | 60-90% |
| | propionate | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl butyrate | TrFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl acetate | TFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl | TFE | 40-95% | 55-90% | 60-90% |
| | propionate | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl butyrate | TFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl acetate | CTFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl | CTFE | 40-95% | 55-90% | 60-90% |
| | propionate | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1233xf | vinyl butyrate | CTFE | 40-95% | 55-90% | 60-90% |
| | | | 1233xf | 1233xf | 1233xf |
| | | | 5-60% 1st | 5-40% 1st | 5-20% 1^{st} |
| | | | 5-55% 2nd | 5-40% 2^{nd} | 5-35% 2^{nd} |
| 1224yd | vinyl acetate | VF | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl | VF | 40-95% | 55-90% | 60-90% |
| | propionate | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl butyrate | VF | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl acetate | VDF | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl | VDF | 40-95% | 55-90% | 60-90% |
| | propionate | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl butyrate | VDF | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl acetate | TrFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl | TrFE | 40-95% | 55-90% | 60-90% |
| | propionate | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl butyrate | TrFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl acetate | TFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl | TFE | 40-95% | 55-90% | 60-90% |
| | propionate | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl butyrate | TFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl acetate | CTFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl | CTFE | 40-95% | 55-90% | 60-90% |
| | propionate | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |
| 1224yd | vinyl butyrate | CTFE | 40-95% | 55-90% | 60-90% |
| | | | 1224yd | 1224yd | 1224yd |
| | | | 5-60% 1st | 5-40% 1st | 5-20% 1^{st} |
| | | | 5-55% 2nd | 5-40% 2^{nd} | 5-35% 2^{nd} |

The fluorocopolymer used in the coatings of the present invention can be formed by copolymerization of the monomers comprising (a), (b) and (c):
(a) about 5-45 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 40-90 mol % of one or more C2-C6 non-cyclic olefin co-monomer, and preferably the halogen containing ethylene-based co-monomer(s) according to either of the formulas as described in the preceeding paragraphs, and combinations of two or more of these.

The fluorocopolymer used in the coatings of the present invention can be formed by copolymerization of the monomers comprising (a), (b) and (c):
(a) about 5-45 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 40-90 mol % of one or more monomers can having the formula:

R¹R₂C═CR¹R₂
wherein R¹ and R² are each independently selected from Cl, H, or F, provided that at least one Cl or F is present on the molecule.

The fluorocopolymer used in the coatings of the present invention can be formed by copolymerization of the monomers comprising (a), (b) and (c):
(a) about 5-45 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 40-90 mol % of one or more monomers can having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 5-55 mol % of one or more hydrofluoroolefin represented by the formula Ia:

(CF₃)(R₁ₐ)C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F;
(b) about 5-60 mol % of one or more co-monomers selected from vinyl esters; and
(c) about 40-90 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 5-55 mol % of one or more hydrofluoroolefin represented by the formula Ia:

(CF₃)(R₁ₐ)C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F;
(b) about 5-60 mol % of one or more co-monomers selected from vinyl esters; and
(c) about 40-90 mol % of one or more monomers having the formula:

R¹R₂C═CR¹R₂
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 5-55 mol % of one or more hydrofluoroolefin represented by the formula Ia:

(CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F;
(b) about 5-60 mol % of one or more co-monomers selected from vinyl esters; and (c) about 40-90 mol % of one or more monomers of the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 5-55 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 40-90 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 5-55 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 40-90 mol % of one or more monomers having the formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 5-55 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 40-90 mol % of one or more monomers having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 5-55 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 40-90 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 5-55 mol % of one or more hydrofluoroolefin represented by the formula Ic:

(CF₃)(R^{1c})C═C(R^{2c})(R^{3c})
wherein:
R_{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 40-90 mol % of one or more monomers having the formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 5-55 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 40-90 mol % of one or more one or more monomers having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 5-55 mol % of one or more hydrofluoroolefin represented by the formula Id:

(CF₃)(R_{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl;
(b) about 5-60 mol % of one or more co-monomers selected from vinyl esters; and
(c) about 40-90 mol % of one or more C2-C6 non-cyclic olefin co-monomer, and preferably the halogen containing ethylene-based co-monomer(s) according to either of the formulas as described in the preceeding paragraphs, and combinations of two or more of these.

The fluorocopolymer can be formed by copolymerization of the monomers comprising (a), (b) and (c):
(a) about 5-55 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl;
(b) about 5-60 mol % of one or more co-monomers selected from vinyl esters; and
(c) about 40-90 mol % of one or more monomers having the formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 5-55 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl;
(b) about 5-60 mol % of one or more co-monomers selected from vinyl esters; and
(c) about 40-90 mol % of one or more monomers having the formula:

H₂C═CR¹R²
wherein R¹ is selected from Cl, H, or F and R² is Cl or F.

The present invention provides the fluorocopolymers as listed in Table 5.

TABLE 5
compositions of terfluorocopolymers

| monomer | | | Mol % ranges | | |
|---|---|---|---|---|---|
| | first co- | second co- | | more | most |
| hydrofluoroolefin | monomer | monomer | preferred | preferred | preferred |
| Formula I | vinyl ester(s) | fluoroethylenes | 5-55% Form. | 5-40% Form. | 5-35% Form. |
| (CF₃)(R¹)C═C(R²)(R³) | | | I | I | I |
| | | | 5-60% 1st | 5-40% 1st | 5-20% 1^{st} |
| | | | 40-90% 2nd | 55-90% 2nd | 60-90% 2nd |
| Formula I | Formula II | fluoroethylenes | 5-55% Form. | 5-40% Form. | 5-35% Form. |
| | (R⁵)₂C═C(R⁶)(O—C═O—R⁷) | | I | I | I |
| | | | 5-60% 1st | 5-40% 1st | 5-20% 1^{st} |
| | | | 40-90% 2nd | 55-90% 2nd | 60-90% 2nd |
| Formula I | Formula IIa | fluoroethylenes | 5-55% Form. | 5-40% Form. | 5-35% Form. |
| | H₂C═CH—O—(C═O)—R⁸ | | I | I | I |
| | | | 5-60% 1st | 5-40% 1st | 5-20% 1^{st} |
| | | | 40-90% 2nd | 55-90% 2nd | 60-90% 2nd |
| Formula Ia | vinyl ester(s) | fluoroethylenes | 5-55% Form. | 5-40% Form. | 5-35% Form. |
| (CF₃)(R^{1a})C═CH₂ | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | Formula II | fluoroethylenes | 5-55% Form. | 5-40% Form. | 5-35% Form. |
| | (R⁵)₂C═C(R⁶)(O—C═O—R⁷) | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | Formula IIa | fluoroethylenes | 5-55% Form. | 5-40% Form. | 5-35% Form. |
| | H₂C═CH—O—(C═O)—R⁸ | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ib | vinyl ester(s) | fluoroethylenes | 5-55% Form. | 5-40% Form. | 5-35% Form. |
| (CF₃)(R^{1b})C═C(R^{2b})(R^{3b}) | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | Formula II | fluoroethylenes | 5-55% Form. | 5-40% Form. | 5-35% Form. |
| | (R⁵)₂C═C(R⁶)(O—C═O—R⁷) | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | Formula IIa | fluoroethylenes | 5-55% Form. | 5-40% Form. | 5-35% Form. |
| | H₂C═CH—O—(C═O)—R⁸ | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ic | vinyl ester(s) | fluoroethylenes | 5-55% Form. | 5-40% Form. | 5-35% Form. |
| (CF₃)(R^{1c})C═C(R^{2c})(R^{3c}) | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | Formula II | fluoroethylenes | 5-55% Form. | 5-40% Form. | 5-35% Form. |
| | (R⁵)₂C═C(R⁶)(O—C═O—R⁷) | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | Formula IIa | fluoroethylenes | 5-55% Form. | 5-40% Form. | 5-35% Form. |
| | H₂C═CH—O—(C═O)—R⁸ | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Id | vinyl ester(s) | fluoroethylenes | 5-55% Form. | 5-40% Form. | 5-35% Form. |
| (CF₃)(R^{1d})C═C(R^{2d})(R^{3d}) | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | Formula II | fluoroethylenes | 5-55% Form. | 5-40% Form. | 5-35% Form. |
| | (R⁵)₂C═C(R⁶)(O—C═O—R⁷) | | Id | Id | Id |
| | | | 5-60% 1st | 5-40% 1st | 5-20% 1^{st} |
| | | | 40-90% 2nd | 55-90% 2nd | 60-90% 2nd |
| Formula Id | Formula IIa | fluoroethylenes | 5-55% Form. | 5-40% Form. | 5-35% Form. |
| | H₂C═CH—O—(C═O)—R⁸ | | Id | Id | Id |
| | | | 5-60% 1st | 5-40% 1st | 5-20% 1^{st} |
| | | | 40-90% 2nd | 55-90% 2nd | 60-90% 2nd |
| 1234yf | vinyl ester(s) | fluoroethylenes | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | Formula II | fluoroethylenes | 5-55% | 5-40% | 5-35% |
| | (R⁵)₂C═C(R⁶)(O—C═O—R⁷) | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | Formula IIa | fluoroethylenes | 5-55% | 5-40% | 5-35% |
| | H₂C═CH—O—(C═O)—R⁸ | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234ze | vinyl ester(s) | fluoroethylenes | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | Formula II | fluoroethylenes | 5-55% | 5-40% | 5-35% |
| | (R⁵)₂C═C(R⁶)(O—C═O—R⁷) | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | Formula IIa | fluoroethylenes | 5-55% | 5-40% | 5-35% |
| | H₂C═CH—O—(C═O)—R⁸ | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl ester(s) | fluoroethylenes | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | Formula II | fluoroethylenes | 5-55% trans- | 5-40% trans- | 5-35% trans- |
| | (R⁵)₂C═C(R⁶)(O—C═O—R⁷) | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | Formula IIa | fluoroethylenes | 5-55% trans- | 5-40% trans- | 5-35% |
| | H₂C═CH—O—(C═O)—R⁸ | | 1234ze | 1234ze | 5-20% 1^{st} |
| | | | 5-60% 1st | 5-40% 1st | 60-90% 2nd |
| | | | 40-90% 2nd | 55-90% 2nd | |
| 1243zf | vinyl ester(s) | fluoroethylenes | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | Formula II | fluoroethylenes | 5-55% | 5-40% | 5-35% |
| | (R⁵)₂C═C(R⁶)(O—C═O—R⁷) | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | Formula IIa | fluoroethylenes | 5-55% | 5-40% | 5-35% |
| | H₂C═CH—O—(C═O)—R⁸ | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1225ye | vinyl ester(s) | fluoroethylenes | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | Formula II | fluoroethylenes | 5-55% | 5-40% | 5-35% |
| | (R⁵)₂C═C(R⁶)(O—C═O—R⁷) | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | Formula IIa | fluoroethylenes | 5-55% | 5-40% | 5-35% |
| | H₂C═CH—O—(C═O)—R⁸ | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1336mzzm | vinyl ester(s) | fluoroethylenes | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | Formula II | fluoroethylenes | 5-55% | 5-40% | 5-35% |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | Formula IIa | fluoroethylenes | 5-55% | 5-40% | 5-35% |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl ester(s) | fluoroethylenes | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | Formula II | fluoroethylenes | 5-55% cis- | 5-40% cis- | 5-35% cis- |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | Formula IIa | fluoroethylenes | 5-55% cis- | 5-40% cis- | 5-35% cis- |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mcfq | vinyl ester(s) | fluoroethylenes | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | Formula II | fluoroethylenes | 5-55% | 5-40% | 5-35% |
| | (R⁵)₂C═C(R⁶)(O—C═O—R⁷) | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | Formula IIa | fluoroethylenes | 5-55% | 5-40% | 5-35% |
| | H₂C═CH—O—(C═O)—R⁸ | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1233zd | vinyl ester(s) | fluoroethylenes | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | Formula II | fluoroethylenes | 5-55% | 5-40% | 5-35% |
| | (R⁵)₂C═C(R⁶)(O—C═O—R⁷) | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | Formula IIa | fluoroethylenes | 5-55% | 5-40% | 5-35% |
| | H₂C═CH—O—(C═O)—R⁸ | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233xf | vinyl ester(s) | fluoroethylenes | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | Formula II | fluoroethylenes | 5-55% | 5-40% | 5-35% |
| | (R⁵)₂C═C(R⁶)(O—C═O—R⁷) | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | Formula IIa | fluoroethylenes | 5-55% | 5-40% | 5-35% |
| | H₂C═CH—O—(C═O)—R⁸ | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1224yd | vinyl ester(s) | fluoroethylenes | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | Formula II | fluoroethylenes | 5-55% | 5-40% | 5-35% |
| | (R⁵)₂C═C(R⁶)(O—C═O—R⁷) | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | Formula IIa | fluoroethylenes | 5-55% | 5-40% | 5-35% |
| | H₂C═CH—O—(C═O)—R⁸ | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |

The present invention further provides the fluorocopolymers as listed in Table 6.

TABLE 6
monomer combinations for terpolymers

| monomer | | | Mol % ranges | | |
|---|---|---|---|---|---|
| | first co- | second co- | | more | most |
| hydrofluoroolefin | monomer | monomer | preferred | preferred | preferred |
| Formula I | vinyl acetate | VF | 5-55% Form. | 5-40% Form. | 5-35% Form. |
| (CF₃)(R¹)C═C(R²)(R³) | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl | VF | 5-55% Form. | 5-40% Form. | 5-35% Form. |
| | propionate | | I | I | I |
| | | | 5-60% 1st | 5-40% 1st | 5-20% 1^{st} |
| | | | 40-90% 2nd | 55-90% 2nd | 60-90% 2nd |
| Formula I | vinyl butyrate | VF | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl acetate | VDF | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl | VDF | 5-55% Form. | 5-40% Form. | 5-35% Form. |
| | propionate | | I | I | I |
| | | | 5-60% 1st | 5-40% 1st | 5-20% 1^{st} |
| | | | 40-90% 2nd | 55-90% 2nd | 60-90% 2nd |
| Formula I | vinyl butyrate | VDF | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl acetate | TrFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl | TrFE | 5-55% Form. | 5-40% Form. | 5-35% Form. |
| | propionate | | I | I | I |
| | | | 5-60% 1st | 5-40% 1st | 5-20% 1^{st} |
| | | | 40-90% 2nd | 55-90% 2nd | 60-90% 2nd |
| Formula I | vinyl butyrate | TrFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl acetate | TFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl | TFE | 5-55% Form. | 5-40% Form. | 5-35% Form. |
| | propionate | | I | I | I |
| | | | 5-60% 1st | 5-40% 1st | 5-20% 1^{st} |
| | | | 40-90% 2nd | 55-90% 2nd | 60-90% 2nd |
| Formula I | vinyl butyrate | TFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl acetate | CTFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula I | vinyl | CTFE | 5-55% Form. | 5-40% Form. | 5-35% Form. |
| | propionate | | I | I | I |
| | | | 5-60% 1st | 5-40% 1st | 5-20% 1^{st} |
| | | | 40-90% 2nd | 55-90% 2nd | 60-90% 2nd |
| Formula I | vinyl butyrate | CTFE | 5-55% Form. | 5-40% Form. | 5-35% Form. |
| | | | I | I | I |
| | | | 5-60% 1st | 5-40% 1st | 5-20% 1^{st} |
| | | | 40-90% 2nd | 55-90% 2nd | 60-90% 2nd |
| Formula Ia | vinyl acetate | VF | 5-55% Form. | 5-40% Form. | 5-35% Form. |
| (CF₃)(R^{1a})C═C(R^{2a})(R^{3a}) | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl | VF | 5-55% Form. | 5-40% Form. | 5-35% Form. |
| | propionate | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl butyrate | VF | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl acetate | VDF | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl | VDF | 5-55% Form. | 5-40% Form. | 5-35% Form. |
| | propionate | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl butyrate | VDF | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl acetate | TrFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl | TrFE | 5-55% Form. | 5-40% Form. | 5-35% Form. |
| | propionate | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl butyrate | TrFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl acetate | TFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl | TFE | 5-55% Form. | 5-40% Form. | 5-35% Form. |
| | propionate | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl butyrate | TFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl acetate | CTFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl | CTFE | 5-55% Form. | 5-40% Form. | 5-35% Form. |
| | propionate | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ia | vinyl butyrate | CTFE | 5-55% Form. | 5-40% Form. | 5-35% Form. |
| | | | Ia | Ia | Ia |
| | | | 5-60% 1st | 5-40% 1st | 5-20% 1^{st} |
| | | | 40-90% 2nd | 55-90% 2nd | 60-90% 2nd |
| Formula Ib | vinyl acetate | VF | 5-55% Form. | 5-40% Form. | 5-35% Form. |
| (CF₃)(R^{1b})C═C(R^{2b})(R^{3b}) | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl | VF | 5-55% Form. | 5-40% Form. | 5-35% Form. |
| | propionate | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl butyrate | VF | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl acetate | VDF | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl | VDF | 5-55% Form. | 5-40% Form. | 5-35% Form. |
| | propionate | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl butyrate | VDF | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl acetate | TrFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl | TrFE | 5-55% Form. | 5-40% Form. | 5-35% Form. |
| | propionate | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl butyrate | TrFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl acetate | TFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl | TFE | 5-55% Form. | 5-40% Form. | 5-35% Form. |
| | propionate | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl butyrate | TFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl acetate | CTFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl | CTFE | 5-55% Form. | 5-40% Form. | 5-35% Form. |
| | propionate | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ib | vinyl butyrate | CTFE | 5-55% Form. | 5-40% Form. | 5-35% Form. |
| | | | Ib | Ib | Ib |
| | | | 5-60% 1st | 5-40% 1st | 5-20% 1^{st} |
| | | | 40-90% 2nd | 55-90% 2nd | 60-90% 2nd |
| Formula Ic | vinyl acetate | VF | 5-55% Form. | 5-40% Form. | 5-35% Form. |
| (CF₃)(R^{1c})C═C(R^{2c})(R^{3c}) | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl | VF | 5-55% Form. | 5-40% Form. | 5-35% Form. |
| | propionate | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl butyrate | VF | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl acetate | VDF | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl | VDF | 5-55% Form. | 5-40% Form. | 5-35% Form. |
| | propionate | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl butyrate | VDF | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl acetate | TrFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl | TrFE | 5-55% Form. | 5-40% Form. | 5-35% Form. |
| | propionate | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl butyrate | TrFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl acetate | TFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl | TFE | 5-55% Form. | 5-40% Form. | 5-35% Form. |
| | propionate | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl butyrate | TFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl acetate | CTFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl | CTFE | 5-55% Form. | 5-40% Form. | 5-35% Form. |
| | propionate | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Ic | vinyl butyrate | CTFE | 5-55% Form. | 5-40% Form. | 5-35% Form. |
| | | | Ic | Ic | Ic |
| | | | 5-60% 1st | 5-40% 1st | 5-20% 1^{st} |
| | | | 40-90% 2nd | 55-90% 2nd | 60-90% 2nd |
| Formula Id | vinyl acetate | VF | 5-55% Form. | 5-40% Form. | 5-35% Form. |
| (CF₃)(R^{1d})C═C(R^{2d})(R^{3d}) | | | I | I | I |
| | | | 5-60% 1st | 5-40% 1st | 5-20% 1^{st} |
| | | | 40-90% 2nd | 55-90% 2nd | 60-90% 2nd |
| Formula Id | vinyl | VF | 5-55% Form. | 5-40% Form. | 5-35% Form. |
| | propionate | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl butyrate | VF | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl acetate | VDF | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl | VDF | 5-55% Form. | 5-40% Form. | 5-35% Form. |
| | propionate | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl butyrate | VDF | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl acetate | TrFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl | TrFE | 5-55% Form. | 5-40% Form. | 5-35% Form. |
| | propionate | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl butyrate | TrFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl acetate | TFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl | TFE | 5-55% Form. | 5-40% Form. | 5-35% Form. |
| | propionate | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl butyrate | TFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl acetate | CTFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl | CTFE | 5-55% Form. | 5-40% Form. | 5-35% Form. |
| | propionate | | Id | Id | Id |
| | | | 5-60% 1st | 5-40% 1st | 5-20% 1^{st} |
| | | | 40-90% 2nd | 55-90% 2nd | 60-90% 2nd |
| Formula Id | vinyl butyrate | CTFE | 5-55% Form. | 5-40% Form. | 5-35% Form. |
| | | | Id | Id | Id |
| | | | 5-60% 1st | 5-40% 1st | 5-20% 1^{st} |
| | | | 40-90% 2nd | 55-90% 2nd | 60-90% 2nd |
| 1234yf | vinyl acetate | VF | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl | VF | 5-55% | 5-40% | 5-35% |
| | propionate | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl butyrate | VF | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl acetate | VDF | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl | VDF | 5-55% | 5-40% | 5-35% |
| | propionate | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl butyrate | VDF | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl acetate | TrFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl | TrFE | 5-55% | 5-40% | 5-35% |
| | propionate | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl butyrate | TrFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl acetate | TFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl | TFE | 5-55% | 5-40% | 5-35% |
| | propionate | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl butyrate | TFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl acetate | CTFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl | CTFE | 5-55% | 5-40% | 5-35% |
| | propionate | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234yf | vinyl butyrate | CTFE | 5-55% | 5-40% | 5-35% |
| | | | 1234yf | 1234yf | 1234yf |
| | | | 5-60% 1st | 5-40% 1st | 5-20% 1^{st} |
| | | | 40-90% 2nd | 55-90% 2nd | 60-90% 2nd |
| 1234ze | vinyl acetate | VF | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl | VF | 5-55% | 5-40% | 5-35% |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl butyrate | VF | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl acetate | VDF | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl | VDF | 5-55% | 5-40% | 5-35% |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl butyrate | VDF | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl acetate | TrFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl | TrFE | 5-55% | 5-40% | 5-35% |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl butyrate | TrFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl acetate | TFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl | TFE | 5-55% | 5-40% | 5-35% |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl butyrate | TFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl acetate | CTFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl | CTFE | 5-55% | 5-40% | 5-35% |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1234ze | vinyl butyrate | CTFE | 5-55% | 5-40% | 5-35% |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl acetate | VF | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl | VF | 5-55% trans- | 5-40% trans- | 5-35% trans- |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl butyrate | VF | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl acetate | VDF | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl | VDF | 5-55% trans- | 5-40% trans- | 5-35% trans- |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl butyrate | VDF | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl acetate | TrFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl | TrFE | 5-55% trans- | 5-40% trans- | 5-35% trans- |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl butyrate | TrFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl acetate | TFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl | TFE | 5-55% trans- | 5-40% trans- | 5-35% trans- |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl butyrate | TFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl acetate | CTFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl | CTFE | 5-55% trans- | 5-40% trans- | 5-35% trans- |
| | propionate | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| trans-1234ze | vinyl butyrate | CTFE | 5-55% trans- | 5-40% trans- | 5-35% trans- |
| | | | 1234ze | 1234ze | 1234ze |
| | | | 5-60% 1st | 5-40% 1st | 5-20% 1^{st} |
| | | | 40-90% 2nd | 55-90% 2nd | 60-90% 2nd |
| 1243zf | vinyl acetate | VF | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl | VF | 5-55% | 5-40% | 5-35% |
| | propionate | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl butyrate | VF | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl acetate | VDF | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl | VDF | 5-55% | 5-40% | 5-35% |
| | propionate | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl butyrate | VDF | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl acetate | TrFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl | TrFE | 5-55% | 5-40% | 5-35% |
| | propionate | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl butyrate | TrFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl acetate | TFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl | TFE | 5-55% | 5-40% | 5-35% |
| | propionate | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl butyrate | TFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl acetate | CTFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl | CTFE | 5-55% | 5-40% | 5-35% |
| | propionate | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1243zf | vinyl butyrate | CTFE | 5-55% | 5-40% | 5-35% |
| | | | 1243zf | 1243zf | 1243zf |
| | | | 5-60% 1st | 5-40% 1st | 5-20% 1^{st} |
| | | | 40-90% 2nd | 55-90% 2nd | 60-90% 2nd |
| 1225ye | vinyl acetate | VF | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl | VF | 5-55% | 5-40% | 5-35% |
| | propionate | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl butyrate | VF | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl acetate | VDF | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl | VDF | 5-55% | 5-40% | 5-35% |
| | propionate | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl butyrate | VDF | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl acetate | TrFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl | TrFE | 5-55% | 5-40% | 5-35% |
| | propionate | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl butyrate | TrFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl acetate | TFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl | TFE | 5-55% | 5-40% | 5-35% |
| | propionate | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl butyrate | TFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl acetate | CTFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl | CTFE | 5-55% | 5-40% | 5-35% |
| | propionate | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1225ye | vinyl butyrate | CTFE | 5-55% | 5-40% | 5-35% |
| | | | 1225ye | 1225ye | 1225ye |
| | | | 5-60% 1st | 5-40% 1st | 5-20% 1^{st} |
| | | | 40-90% 2nd | 55-90% 2nd | 60-90% 2nd |
| 1336mzzm | vinyl acetate | VF | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl | VF | 5-55% | 5-40% | 5-35% |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl butyrate | VF | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl acetate | VDF | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl | VDF | 5-55% | 5-40% | 5-35% |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl butyrate | VDF | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl acetate | TrFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl | TrFE | 5-55% | 5-40% | 5-35% |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl butyrate | TrFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl acetate | TFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl | TFE | 5-55% | 5-40% | 5-35% |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl butyrate | TFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl acetate | CTFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl | CTFE | 5-55% | 5-40% | 5-35% |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mzzm | vinyl butyrate | CTFE | 5-55% | 5-40% | 5-35% |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl acetate | VF | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl | VF | 5-55% cis- | 5-40% cis- | 5-35% cis- |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl butyrate | VF | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl acetate | VDF | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl | VDF | 5-55% cis- | 5-40% cis- | 5-35% cis- |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl butyrate | VDF | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl acetate | TrFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl | TrFE | 5-55% cis- | 5-40% cis- | 5-35% cis- |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl butyrate | TrFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl acetate | TFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl | TFE | 5-55% cis- | 5-40% cis- | 5-35% cis- |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl butyrate | TFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl acetate | CTFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl | CTFE | 5-55% cis- | 5-40% cis- | 5-35% cis- |
| | propionate | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| cis-1336mzzm | vinyl butyrate | CTFE | 5-55% cis- | 5-40% cis- | 5-35% cis- |
| | | | 1336mzzm | 1336mzzm | 1336mzzm |
| | | | 5-60% 1st | 5-40% 1st | 5-20% 1^{st} |
| | | | 40-90% 2nd | 55-90% 2nd | 60-90% 2nd |
| 1336mcfq | vinyl acetate | VF | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl | VF | 5-55% | 5-40% | 5-35% |
| | propionate | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl butyrate | VF | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl acetate | VDF | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl | VDF | 5-55% | 5-40% | 5-35% |
| | propionate | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl butyrate | VDF | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl acetate | TrFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl | TrFE | 5-55% | 5-40% | 5-35% |
| | propionate | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl butyrate | TrFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl acetate | TFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl | TFE | 5-55% | 5-40% | 5-35% |
| | propionate | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl butyrate | TFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl acetate | CTFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl | CTFE | 5-55% | 5-40% | 5-35% |
| | propionate | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1336mcfq | vinyl butyrate | CTFE | 5-55% | 5-40% | 5-35% |
| | | | 1336mcfq | 1336mcfq | 1336mcfq |
| | | | 5-60% 1st | 5-40% 1st | 5-20% 1^{st} |
| | | | 40-90% 2nd | 55-90% 2nd | 60-90% 2nd |
| 1233zd | vinyl acetate | VF | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl | VF | 5-55% | 5-40% | 5-35% |
| | propionate | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl butyrate | VF | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl acetate | VDF | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl | VDF | 5-55% | 5-40% | 5-35% |
| | propionate | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl butyrate | VDF | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl acetate | TrFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl | TrFE | 5-55% | 5-40% | 5-35% |
| | propionate | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl butyrate | TrFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl acetate | TFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl | TFE | 5-55% | 5-40% | 5-35% |
| | propionate | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl butyrate | TFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl acetate | CTFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl | CTFE | 5-55% | 5-40% | 5-35% |
| | propionate | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233zd | vinyl butyrate | CTFE | 5-55% | 5-40% | 5-35% |
| | | | 1233zd | 1233zd | 1233zd |
| | | | 5-60% 1st | 5-40% 1st | 5-20% 1^{st} |
| | | | 40-90% 2nd | 55-90% 2nd | 60-90% 2nd |
| 1233xf | vinyl acetate | VF | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl | VF | 5-55% | 5-40% | 5-35% |
| | propionate | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl butyrate | VF | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl acetate | VDF | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl | VDF | 5-55% | 5-40% | 5-35% |
| | propionate | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl butyrate | VDF | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl acetate | TrFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl | TrFE | 5-55% | 5-40% | 5-35% |
| | propionate | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl butyrate | TrFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl acetate | TFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl | TFE | 5-55% | 5-40% | 5-35% |
| | propionate | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl butyrate | TFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl acetate | CTFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl | CTFE | 5-55% | 5-40% | 5-35% |
| | propionate | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1233xf | vinyl butyrate | CTFE | 5-55% | 5-40% | 5-35% |
| | | | 1233xf | 1233xf | 1233xf |
| | | | 5-60% 1st | 5-40% 1st | 5-20% 1^{st} |
| | | | 40-90% 2nd | 55-90% 2nd | 60-90% 2nd |
| 1224yd | vinyl acetate | VF | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl | VF | 5-55% | 5-40% | 5-35% |
| | propionate | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl butyrate | VF | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl acetate | VDF | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl | VDF | 5-55% | 5-40% | 5-35% |
| | propionate | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl butyrate | VDF | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl acetate | TrFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl | TrFE | 5-55% | 5-40% | 5-35% |
| | propionate | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl butyrate | TrFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl acetate | TFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl | TFE | 5-55% | 5-40% | 5-35% |
| | propionate | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl butyrate | TFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl acetate | CTFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl | CTFE | 5-55% | 5-40% | 5-35% |
| | propionate | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |
| 1224yd | vinyl butyrate | CTFE | 5-55% | 5-40% | 5-35% |
| | | | 1224yd | 1224yd | 1224yd |
| | | | 5-60% 1st | 5-40% 1st | 5-20% 1^{st} |
| | | | 40-90% 2nd | 55-90% 2nd | 60-90% 2nd |

The fluorocopolymer used in the coatings of the present invention can be formed by copolymerization of the monomers comprising (a), (b) and (c):
(a) about 20-75 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 20-75 mol % of one or more C2-C6 non-cyclic olefin co-monomer, and preferably the halogen containing ethylene-based co-monomer(s) according to either of the formulas as described in the preceeding paragraphs.

The fluorocopolymer used in the coatings of the present invention can be formed by copolymerization of the monomers comprising (a), (b) and (c):
(a) about 20-75 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 20-75 mol % of one or more havinge the formula:

R¹R²C═CR¹R²
wherein R¹ and R² are each independently selected from Cl, H, or F, provided that at least one Cl or F is present on the molecule.

The fluorocopolymer used in the coatings of the present invention can be formed by copolymerization of the monomers comprising (a), (b) and (c):
(a) about 20-75 mol % of one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F;
(b) about 5-60 mol % of one or more co-monomers selected from vinyl esters; and
(c) about 20-75 mol % of one or more having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 20-75 mol % of one or more hydrofluoroolefin represented by the formula Ia:

((CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
   R^{3a} is selected from the group consisting of H and F;
(b) about 5-60 mol % of one or more co-monomers selected from vinyl esters; and
(c) about 20-75 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 20-75 mol % of one or more hydrofluoroolefin represented by the formula Ia:

((CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
   R^{3a} is selected from the group consisting of H and F;
(b) about 5-60 mol % of one or more co-monomers selected from vinyl esters; and
(c) about 20-75 mol % of one or more formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 20-75 mol % of one or more hydrofluoroolefin represented by the formula Ia:

((CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
   R^{3a} is selected from the group consisting of H and F;
(b) about 5-60 mol % of one or more co-monomers selected from vinyl esters; and
(c) about 20-75 mol % of one or more formula:

H₂C═CR¹R²
wherein R¹ is selected from Cl, H, or F and R² is Cl or F.

The fluorocopolymer can be formed by copolymerization of the monomers comprising (a), (b) and (c):
(a) about 20-75 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 20-75 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 20-75 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 20-75 mol % of one or more of monomer according to the following formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 20-75 mol % of one or more hydrofluoroolefin represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H;
(b) about 5-60 mol % of one or more co-monomers selected from vinyl esters; and
(c) about 20-75 mol % of one or more monomers having the formula:

H₂C═CR¹R²
wherein R¹ is selected from Cl, H, or F and R² is Cl or F.

The fluorocopolymer can be formed by copolymerization of the monomers comprising (a), (b) and (c):
(a) about 20-75 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 20-75 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 20-75 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 20-75 mol % of one or more one or more of monomer according to the following formula:

R¹R²C═CR¹R²
wherein R¹ and R² are each independently selected from Cl, H, or F, provided that at least one Cl or F is present on the molecule.

The fluorocopolymer can be formed by copolymerization of the monomers comprising (a), (b) and (c):
(a) about 20-75 mol % of one or more hydrofluoroolefin represented by the formula Ic:

(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F;
(b) about 5-60 mol % of one or more co-monomers selected from vinyl esters; and
(c) about 20-75 mol % of one or more one or more monomer according to the following formula:

R¹R²C═CR¹R²
wherein R¹ and R² are each independently selected from Cl, H, or F, provided that at least one Cl or F is present on the molecule.

H₂C═CR¹R²
wherein R¹ is selected from Cl, H, or F and R² is Cl or F.

The fluorocopolymer can be formed by copolymerization of the monomers comprising (a), (b) and (c):
(a) about 20-75 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is C1;
(b) about 5-60 mol % of one or more co-monomers selected from vinyl esters; and
(c) about 20-75 mol % of one or more C2-C6 non-cyclic olefin co-monomer, and preferably the halogen containing ethylene-based co-monomer(s) according to either of the formulas as described in the preceeding paragraphs.

The fluorocopolymer can be formed by copolymerization of the monomers comprising (a), (b) and (c):
(a) about 20-75 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is C1;
(b) about 5-60 mol % of one or more co-monomers selected from vinyl esters; and
(c) about 20-75 mol % of one or more monomer according to the following formula:

R¹R²C═CR¹R²

wherein R¹ and R² are each independently selected from Cl, H, or F, provided that at least one Cl or F is present on the molecule.

The fluorocopolymer can be formed by copolymerization of the monomers comprising (a), (b) and (c):
(a) about 20-75 mol % of one or more hydrofluoroolefin represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is C1;
(b) about 5-60 mol % of one or more co-monomers selected from vinyl esters; and
(c) about 20-75 mol % of one or more monomer having the formula:

H₂C═CR¹R²
wherein R¹ is selected from Cl, H, or F and R² is Cl or F.

The present invention provides the fluorocopolymers as listed in Table 7.

TABLE 7
compositions of terfluorocopolymers

| monomer | | | Mol % ranges | | |
|---|---|---|---|---|---|
| | first co- | second co- | | more | most |
| hydrofluoroolefin | monomer | monomer | preferred | preferred | preferred |
| Formula I | vinyl ester(s) | fluoroethylenes | 20-75% | 30-65% | 40-55% |
| (CF₃)(R¹)C═C(R²)(R³) | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | Formula II | fluoroethylenes | 20-75% | 30-65% | 40-55% |
| | (R⁵)₂C═C(R⁶)(O—C═O—R⁷) | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | Formula IIa | fluoroethylenes | 20-75% | 30-65% | 40-55% |
| | H₂C═CH—O—(C═O)—R⁸ | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula Ia | vinyl ester(s) | fluoroethylenes | 20-75% | 30-65% | 40-55% |
| (CF₃)(R^{1a})C═CH₂ | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | Formula II | fluoroethylenes | 20-75% | 30-65% | 40-55% |
| | (R⁵)₂C═C(R⁶)(O—C═O—R⁷) | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | Formula IIa | fluoroethylenes | 20-75% | 30-65% | 40-55% |
| | H₂C═CH—O—(C═O)—R⁸ | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ib | vinyl ester(s) | fluoroethylenes | 20-75% | 30-65% | 40-55% |
| (CF₃)(R^{1b})C═C(R^{2b})(R^{3b}) | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | Formula II | fluoroethylenes | 20-75% | 30-65% | 40-55% |
| | (R⁵)₂C═C(R⁶)(O—C═O—R⁷) | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | Formula IIa | fluoroethylenes | 20-75% | 30-65% | 40-55% |
| | H₂C═CH—O—(C═O)—R⁸ | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ic | vinyl ester(s) | fluoroethylenes | 20-75% | 30-65% | 40-55% |
| (CF₃)(R^{1c})C═C(R^{2c})(R^{3c}) | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | Formula II | fluoroethylenes | 20-75% | 30-65% | 40-55% |
| | (R⁵)₂C═C(R⁶)(O—C═O—R⁷) | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | Formula IIa | fluoroethylenes | 20-75% | 30-65% | 40-55% |
| | H₂C═CH—O—(C═O)—R⁸ | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Id | vinyl ester(s) | fluoroethylenes | 20-75% | 30-65% | 40-55% |
| (CF₃)(R^{1d})C═C(R^{2d})(R^{3d}) | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | Formula II | fluoroethylenes | 20-75% | 30-65% | 40-55% |
| | (R⁵)₂C═C(R⁶)(O—C═O—R⁷) | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | Formula IIa | fluoroethylenes | 20-75% | 30-65% | 40-55% |
| | H₂C═CH—O—(C═O)—R⁸ | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| 1234yf | vinyl ester(s) | fluoroethylenes | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | Formula II | fluoroethylenes | 20-75% | 30-65% | 40-55% |
| | (R⁵)₂C═C(R⁶)(O—C═O—R⁷) | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | Formula IIa | fluoroethylenes | 20-75% | 30-65% | 40-55% |
| | H₂C═CH—O—(C═O)—R⁸ | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234ze | vinyl ester(s) | fluoroethylenes | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | Formula II | fluoroethylenes | 20-75% | 30-65% | 40-55% |
| | (R⁵)₂C═C(R⁶)(O—C═O—R⁷) | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | Formula IIa | fluoroethylenes | 20-75% | 30-65% | 40-55% |
| | H₂C═CH—O—(C═O)—R⁸ | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| trans-1234ze | vinyl ester(s) | fluoroethylenes | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | Formula II | fluoroethylenes | 20-75% | 30-65% | 40-55% |
| | (R⁵)₂C═C(R⁶)(O—C═O—R⁷) | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | Formula IIa | fluoroethylenes | 20-75% | 30-65% | 40-55% |
| | H₂C═CH—O—(C═O)—R⁸ | | trans-1234ze | trans-1234ze | 5-20% 1^{st} |
| | | | 5-60% 1st | 5-40% 1st | 40-55% 2nd |
| | | | 20-75% 2nd | 30-65% 2nd | |
| 1243zf | vinyl ester(s) | fluoroethylenes | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | Formula II | fluoroethylenes | 20-75% | 30-65% | 40-55% |
| | (R⁵)₂C═C(R⁶)(O—C═O—R⁷) | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | Formula IIa | fluoroethylenes | 20-75% | 30-65% | 40-55% |
| | H₂C═CH—O—(C═O)—R⁸ | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1225ye | vinyl ester(s) | fluoroethylenes | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | Formula II | fluoroethylenes | 20-75% | 30-65% | 40-55% |
| | (R⁵)₂C═C(R⁶)(O—C═O—R⁷) | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | Formula IIa | fluoroethylenes | 20-75% | 30-65% | 40-55% |
| | H₂C═CH—O—(C═O)—R⁸ | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1336mzzm | vinyl ester(s) | fluoroethylenes | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | Formula II | fluoroethylenes | 20-75% | 30-65% | 40-55% |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | Formula IIa | fluoroethylenes | 20-75% | 30-65% | 40-55% |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl ester(s) | fluoroethylenes | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | Formula II | fluoroethylenes | 20-75% cis- | 30-65% cis- | 40-55% cis- |
| | (R⁵)₂C═C(R⁶)(O—C═O—R⁷) | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | Formula IIa | fluoroethylenes | 20-75% cis- | 30-65% cis- | 40-55% cis- |
| | H₂C═CH—O—(C═O)—R⁸ | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mcfq | vinyl ester(s) | fluoroethylenes | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | Formula II | fluoroethylenes | 20-75% | 30-65% | 40-55% |
| | (R⁵)₂C═C(R⁶)(O—C═O—R⁷) | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | Formula IIa | fluoroethylenes | 20-75% | 30-65% | 40-55% |
| | H₂C═CH—O—(C═O)—R⁸ | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1233zd | vinyl ester(s) | fluoroethylenes | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | Formula II | fluoroethylenes | 20-75% | 30-65% | 40-55% |
| | (R⁵)₂C═C(R⁶)(O—C═O—R⁷) | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | Formula IIa | fluoroethylenes | 20-75% | 30-65% | 40-55% |
| | H₂C═CH—O—(C═O)—R⁸ | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233xf | vinyl ester(s) | fluoroethylenes | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | Formula II | fluoroethylenes | 20-75% | 30-65% | 40-55% |
| | (R⁵)₂C═C(R⁶)(O—C═O—R⁷) | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | Formula IIa | fluoroethylenes | 20-75% | 30-65% | 40-55% |
| | H₂C═CH—O—(C═O)—R⁸ | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1224yd | vinyl ester(s) | fluoroethylenes | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | Formula II | fluoroethylenes | 20-75% | 30-65% | 40-55% |
| | (R⁵)₂C═C(R⁶)(O—C═O—R⁷) | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | Formula IIa | fluoroethylenes | 20-75% | 30-65% | 40-55% |
| | H₂C═CH—O—(C═O)—R⁸ | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |

The present invention further provides the fluorocopolymers as listed in Table 8.

TABLE 8
monomer combinations for terfluoropolymers

| monomer | | | | | |
|---|---|---|---|---|---|
| | | second | Mol% ranges | | |
| | first co- | co- | | more | most |
| hydrofluoroolefin | monomer | monomer | preferred | preferred | preferred |
| Formula I | vinyl acetate | VF | 20-75% | 30-65% | 40-55% |
| (CF₃)(R¹)C═C(R²)(R³) | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl | VF | 20-75% | 30-65% | 40-55% |
| | propionate | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl butyrate | VF | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl acetate | VDF | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl | VDF | 20-75% | 30-65% | 40-55% |
| | propionate | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl butyrate | VDF | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl acetate | TrFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl | TrFE | 20-75% | 30-65% | 40-55% |
| | propionate | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl butyrate | TrFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl acetate | TFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl | TFE | 20-75% | 30-65% | 40-55% |
| | propionate | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl butyrate | TFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl acetate | CTFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl | CTFE | 20-75% | 30-65% | 40-55% |
| | propionate | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula I | vinyl butyrate | CTFE | 20-75% | 30-65% | 40-55% |
| | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula Ia | vinyl acetate | VF | 20-75% | 30-65% | 40-55% |
| (CF₃)(R^{1a})C═C(R^{2a})(R^{3a}) | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl | VF | 20-75% | 30-65% | 40-55% |
| | propionate | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl butyrate | VF | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl acetate | VDF | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl | VDF | 20-75% | 30-65% | 40-55% |
| | propionate | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl butyrate | VDF | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl acetate | TrFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl | TrFE | 20-75% | 30-65% | 40-55% |
| | propionate | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl butyrate | TrFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl acetate | TFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl | TFE | 20-75% | 30-65% | 40-55% |
| | propionate | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl butyrate | TFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl acetate | CTFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl | CTFE | 20-75% | 30-65% | 40-55% |
| | propionate | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ia | vinyl butyrate | CTFE | 20-75% | 30-65% | 40-55% |
| | | | Form. Ia | Form. Ia | Form. Ia |
| | | | 5-60% 1st | 5-40% 1st | 5-20% 1^{st} |
| | | | 20-75% 2nd | 30-65% 2nd | 40-55% 2nd |
| Formula Ib | vinyl acetate | VF | 20-75% | 30-65% | 40-55% |
| (CF₃)(R^{1b})C═C(R^{2b})(R^{3b}) | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl | VF | 20-75% | 30-65% | 40-55% |
| | propionate | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl butyrate | VF | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl acetate | VDF | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl | VDF | 20-75% | 30-65% | 40-55% |
| | propionate | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl butyrate | VDF | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl acetate | TrFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl | TrFE | 20-75% | 30-65% | 40-55% |
| | propionate | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl butyrate | TrFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl acetate | TFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl | TFE | 20-75% | 30-65% | 40-55% |
| | propionate | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl butyrate | TFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl acetate | CTFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl | CTFE | 20-75% | 30-65% | 40-55% |
| | propionate | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ib | vinyl butyrate | CTFE | 20-75% | 30-65% | 40-55% |
| | | | Form. Ib | Form. Ib | Form. Ib |
| | | | 5-60% 1st | 5-40% 1st | 5-20% 1^{st} |
| | | | 20-75% 2nd | 30-65% 2nd | 40-55% 2nd |
| Formula Ic | vinyl acetate | VF | 20-75% | 30-65% | 40-55% |
| (CF₃)(R^{1c})C═C(R^{2c})(R^{3c}) | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl | VF | 20-75% | 30-65% | 40-55% |
| | propionate | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl butyrate | VF | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl acetate | VDF | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl | VDF | 20-75% | 30-65% | 40-55% |
| | propionate | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl butyrate | VDF | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl acetate | TrFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl | TrFE | 20-75% | 30-65% | 40-55% |
| | propionate | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl butyrate | TrFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl acetate | TFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl | TFE | 20-75% | 30-65% | 40-55% |
| | propionate | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl butyrate | TFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl acetate | CTFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl | CTFE | 20-75% | 30-65% | 40-55% |
| | propionate | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Ic | vinyl butyrate | CTFE | 20-75% | 30-65% | 40-55% |
| | | | Form. Ic | Form. Ic | Form. Ic |
| | | | 5-60% 1st | 5-40% 1st | 5-20% 1^{st} |
| | | | 20-75% 2nd | 30-65% 2nd | 40-55% 2nd |
| Formula Id | vinyl acetate | VF | 20-75% | 30-65% | 40-55% |
| (CF³)(R^{1d})C═C(R^{2d})(R^{3d}) | | | Form. I | Form. I | Form. I |
| | | | 5-60% 1st | 5-40% 1st | 5-20% 1^{st} |
| | | | 20-75% 2nd | 30-65% 2nd | 40-55% 2nd |
| Formula Id | vinyl | VF | 20-75% | 30-65% | 40-55% |
| | propionate | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl butyrate | VF | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl acetate | VDF | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl | VDF | 20-75% | 30-65% | 40-55% |
| | propionate | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl butyrate | VDF | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl acetate | TrFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl | TrFE | 20-75% | 30-65% | 40-55% |
| | propionate | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl butyrate | TrFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl acetate | TFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl | TFE | 20-75% | 30-65% | 40-55% |
| | propionate | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl butyrate | TFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl acetate | CTFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl | CTFE | 20-75% | 30-65% | 40-55% |
| | propionate | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| Formula Id | vinyl butyrate | CTFE | 20-75% | 30-65% | 40-55% |
| | | | Form. Id | Form. Id | Form. Id |
| | | | 5-60% 1st | 5-40% 1st | 5-20% 1^{st} |
| | | | 20-75% 2nd | 30-65% 2nd | 40-55% 2nd |
| 1234yf | vinyl acetate | VF | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl | VF | 20-75% | 30-65% | 40-55% |
| | propionate | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl butyrate | VF | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl acetate | VDF | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl | VDF | 20-75% | 30-65% | 40-55% |
| | propionate | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl butyrate | VDF | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl acetate | TrFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl | TrFE | 20-75% | 30-65% | 40-55% |
| | propionate | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl butyrate | TrFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl acetate | TFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl | TFE | 20-75% | 30-65% | 40-55% |
| | propionate | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl butyrate | TFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl acetate | CTFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl | CTFE | 20-75% | 30-65% | 40-55% |
| | propionate | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234yf | vinyl butyrate | CTFE | 20-75% | 30-65% | 40-55% |
| | | | 1234yf | 1234yf | 1234yf |
| | | | 5-60% 1st | 5-40% 1st | 5-20% 1^{st} |
| | | | 20-75% 2nd | 30-65% 2nd | 40-55% 2nd |
| 1234ze | vinyl acetate | VF | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl | VF | 20-75% | 30-65% | 40-55% |
| | propionate | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl butyrate | VF | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl acetate | VDF | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl | VDF | 20-75% | 30-65% | 40-55% |
| | propionate | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl butyrate | VDF | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl acetate | TrFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl | TrFE | 20-75% | 30-65% | 40-55% |
| | propionate | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl butyrate | TrFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl acetate | TFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl | TFE | 20-75% | 30-65% | 40-55% |
| | propionate | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl butyrate | TFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl acetate | CTFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl | CTFE | 20-75% | 30-65% | 40-55% |
| | propionate | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| 1234ze | vinyl butyrate | CTFE | 20-75% | 30-65% | 40-55% |
| | | | 1234ze | 1234ze | 1234ze |
| | | | 5-60% 1st | 5-40% 1st | 5-20% 1^{st} |
| | | | 20-75% 2nd | 30-65% 2nd | 40-55% 2nd |
| trans-1234ze | vinyl acetate | VF | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl | VF | 20-75% | 30-65% | 40-55% |
| | propionate | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl butyrate | VF | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl acetate | VDF | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl | VDF | 20-75% | 30-65% | 40-55% |
| | propionate | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl butyrate | VDF | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl acetate | TrFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl | TrFE | 20-75% | 30-65% | 40-55% |
| | propionate | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl butyrate | TrFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl acetate | TFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl | TFE | 20-75% | 30-65% | 40-55% |
| | propionate | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl butyrate | TFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl acetate | CTFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl | CTFE | 20-75% | 30-65% | 40-55% |
| | propionate | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| trans-1234ze | vinyl butyrate | CTFE | 20-75% | 30-65% | 40-55% |
| | | | trans-1234ze | trans-1234ze | trans-1234ze |
| | | | 5-60% 1st | 5-40% 1st | 5-20% 1^{st} |
| | | | 20-75% 2nd | 30-65% 2nd | 40-55% 2nd |
| 1243zf | vinyl acetate | VF | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl | VF | 20-75% | 30-65% | 40-55% |
| | propionate | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl butyrate | VF | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl acetate | VDF | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl | VDF | 20-75% | 30-65% | 40-55% |
| | propionate | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl butyrate | VDF | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl acetate | TrFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl | TrFE | 20-75% | 30-65% | 40-55% |
| | propionate | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl butyrate | TrFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl acetate | TFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl | TFE | 20-75% | 30-65% | 40-55% |
| | propionate | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl butyrate | TFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl acetate | CTFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl | CTFE | 20-75% | 30-65% | 40-55% |
| | propionate | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1243zf | vinyl butyrate | CTFE | 20-75% | 30-65% | 40-55% |
| | | | 1243zf | 1243zf | 1243zf |
| | | | 5-60% 1st | 5-40% 1st | 5-20% 1^{st} |
| | | | 20-75% 2nd | 30-65% 2nd | 40-55% 2nd |
| 1225ye | vinyl acetate | VF | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl | VF | 20-75% | 30-65% | 40-55% |
| | propionate | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl butyrate | VF | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl acetate | VDF | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl | VDF | 20-75% | 30-65% | 40-55% |
| | propionate | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl butyrate | VDF | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl acetate | TrFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl | TrFE | 20-75% | 30-65% | 40-55% |
| | propionate | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl butyrate | TrFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl acetate | TFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl | TFE | 20-75% | 30-65% | 40-55% |
| | propionate | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl butyrate | TFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl acetate | CTFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl | CTFE | 20-75% | 30-65% | 40-55% |
| | propionate | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1225ye | vinyl butyrate | CTFE | 20-75% | 30-65% | 40-55% |
| | | | 1225ye | 1225ye | 1225ye |
| | | | 5-60% 1st | 5-40% 1st | 5-20% 1^{st} |
| | | | 20-75% 2nd | 30-65% 2nd | 40-55% 2nd |
| 1336mzzm | vinyl acetate | VF | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl | VF | 20-75% | 30-65% | 40-55% |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl butyrate | VF | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl acetate | VDF | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl | VDF | 20-75% | 30-65% | 40-55% |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl butyrate | VDF | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl acetate | TrFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl | TrFE | 20-75% | 30-65% | 40-55% |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl butyrate | TrFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl acetate | TFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl | TFE | 20-75% | 30-65% | 40-55% |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl butyrate | TFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl acetate | CTFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl | CTFE | 20-75% | 30-65% | 40-55% |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mzzm | vinyl butyrate | CTFE | 20-75% | 30-65% | 40-55% |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl acetate | VF | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl | VF | 20-75% cis- | 30-65% cis- | 40-55% cis- |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl butyrate | VF | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl acetate | VDF | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl | VDF | 20-75% cis- | 30-65% cis- | 40-55% cis- |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl butyrate | VDF | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl acetate | TrFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl | TrFE | 20-75% cis- | 30-65% cis- | 40-55% cis- |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl butyrate | TrFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl acetate | TFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl | TFE | 20-75% cis- | 30-65% cis- | 40-55% cis- |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl butyrate | TFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl acetate | CTFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl | CTFE | 20-75% cis- | 30-65% cis- | 40-55% cis- |
| | propionate | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| cis-1336mzzm | vinyl butyrate | CTFE | 20-75% cis- | 30-65% cis- | 40-55% cis- |
| | | | 1336mzzm | 1336mzzm | 1336mzzm |
| | | | 5-60% 1st | 5-40% 1st | 5-20% 1^{st} |
| | | | 20-75% 2nd | 30-65% 2nd | 40-55% 2nd |
| 1336mcfq | vinyl acetate | VF | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl | VF | 20-75% | 30-65% | 40-55% |
| | propionate | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl butyrate | VF | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl acetate | VDF | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl | VDF | 20-75% | 30-65% | 40-55% |
| | propionate | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl butyrate | VDF | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl acetate | TrFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl | TrFE | 20-75% | 30-65% | 40-55% |
| | propionate | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl butyrate | TrFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl acetate | TFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl | TFE | 20-75% | 30-65% | 40-55% |
| | propionate | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl butyrate | TFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl acetate | CTFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl | CTFE | 20-75% | 30-65% | 40-55% |
| | propionate | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1336mcfq | vinyl butyrate | CTFE | 20-75% | 30-65% | 40-55% |
| | | | 1336mcfq | 1336mcfq | 1336mcfq |
| | | | 5-60% 1st | 5-40% 1st | 5-20% 1^{st} |
| | | | 20-75% 2nd | 30-65% 2nd | 40-55% 2nd |
| 1233zd | vinyl acetate | VF | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl | VF | 20-75% | 30-65% | 40-55% |
| | propionate | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl butyrate | VF | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl acetate | VDF | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl | VDF | 20-75% | 30-65% | 40-55% |
| | propionate | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl butyrate | VDF | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl acetate | TrFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl | TrFE | 20-75% | 30-65% | 40-55% |
| | propionate | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl butyrate | TrFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl acetate | TFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl | TFE | 20-75% | 30-65% | 40-55% |
| | propionate | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl butyrate | TFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl acetate | CTFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl | CTFE | 20-75% | 30-65% | 40-55% |
| | propionate | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233zd | vinyl butyrate | CTFE | 20-75% | 30-65% | 40-55% |
| | | | 1233zd | 1233zd | 1233zd |
| | | | 5-60% 1st | 5-40% 1st | 5-20% 1^{st} |
| | | | 20-75% 2nd | 30-65% 2nd | 40-55% 2nd |
| 1233xf | vinyl acetate | VF | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl | VF | 20-75% | 30-65% | 40-55% |
| | propionate | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl butyrate | VF | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl acetate | VDF | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl | VDF | 20-75% | 30-65% | 40-55% |
| | propionate | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl butyrate | VDF | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl acetate | TrFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl | TrFE | 20-75% | 30-65% | 40-55% |
| | propionate | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl butyrate | TrFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl acetate | TFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl | TFE | 20-75% | 30-65% | 40-55% |
| | propionate | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl butyrate | TFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl acetate | CTFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl | CTFE | 20-75% | 30-65% | 40-55% |
| | propionate | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1233xf | vinyl butyrate | CTFE | 20-75% | 30-65% | 40-55% |
| | | | 1233xf | 1233xf | 1233xf |
| | | | 5-60% 1st | 5-40% 1st | 5-20% 1^{st} |
| | | | 20-75% 2nd | 30-65% 2nd | 40-55% 2nd |
| 1224yd | vinyl acetate | VF | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl | VF | 20-75% | 30-65% | 40-55% |
| | propionate | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl butyrate | VF | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl acetate | VDF | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl | VDF | 20-75% | 30-65% | 40-55% |
| | propionate | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl butyrate | VDF | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl acetate | TrFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl | TrFE | 20-75% | 30-65% | 40-55% |
| | propionate | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl butyrate | TrFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl acetate | TFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl | TFE | 20-75% | 30-65% | 40-55% |
| | propionate | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl butyrate | TFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl acetate | CTFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl | CTFE | 20-75% | 30-65% | 40-55% |
| | propionate | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |
| 1224yd | vinyl butyrate | CTFE | 20-75% | 30-65% | 40-55% |
| | | | 1224yd | 1224yd | 1224yd |
| | | | 5-60% 1st | 5-40% 1st | 5-20% 1^{st} |
| | | | 20-75% 2nd | 30-65% 2nd | 40-55% 2nd |

The fluorocopolymers used in the present invention may comprise the above weight percentages of the hydrofluoroolefin monomer and the co-monomer. The fluorocopolymers used in the present invention can consist essentially of the above weight percentages of the hydrofluoroolefin monomer and the co-monomer. The fluorocopolymers used in the present invention can consist of the above weight percentages of the hydrofluoroolefin and the co-monomer.

### Polymer Preparation

The fluorocopolymers according to the present invention may be formed using one or a combination of different applications and techniques known in the art. For example, the fluorocopolymers may be formed using one or a combination of several preferred techniques, including, solution, emulsion polymerization, or suspension polymerization and combinations thereof. The process operation may be carried out in batch, semi-batch or continuous mode.

Polymerization is carried out in the presence of one or more free-radical initiators. Initiators include azobiscyano initiators such as azobisisobutyronitrile (AIBN), aliphatic peresters such as t-butyl peroctoate and t-amyl peroctoate, peroxides such as tert-butyl peroxide, and hydroperoxides such as tert-butyl hydroperoxide. Suitable initiators include persulfates such as sodium persulfate, potassium persulfate, ammonium persulfate and iron persulfate, and combinations of the foregoing. A persulfate initiator may be particularly suitable for emulsion polymerization. The initiator may be included in the reaction solution at a concentration of less than 20 wt %, more particularly less than 12 wt % and even more particularly less than 1.0 wt % based on the total weight of the monomers.

The fluorocopolymer is preferably produced in a polymerization system that utilizes a carrier for the monomer/polymer during and/or after formation. The carrier acts as a solvent and/or dispersant for the monomer and/or polymer, and such operations include suspension, dispersion, emulsion and solution polymerization. Examples of carriers in such systems, including preferably solvents for solution polymerization, include: esters, such as methyl acetate, ethyl acetate, propyl acetate and butyl acetate; ketones, such as acetone, methyl ethyl acetone and cyclohexanone; aliphatic hydrocarbons, such as hexane, cyclohexane, octane, nonane, decane, undecane, dodecane, and mineral spirits; aromatic hydrocarbons, such as benzene, toluene, xylene, naphthalene, and solvent napthta; alcohols, such as methanol, ethanol, tert-butanol, iso-propanol, ethylene glycol monoalkyl ethers; cyclic ethers, such as tetrahydrofuran, tetrahydropyran, and dioxane; fluorinated solvents, such as HCFC-225 and HCFC-141b; dimethyl sulfoxide; and the mixtures thereof. In certain embodiments, the solvent used in the solution copolymerization process comprises, preferably consists essentially of, and more preferably in certain embodiments consists of C2-C5 alkyl acetate, and even more preferably butyl acetate.

It is contemplated that the temperature conditions used in the polymerization process of the present invention can be varied according to the particular equipment and applications involved and all such temperatures are within the scope of the present invention. Preferably, the polymerization is conducted at a temperature in a range of from about 30° C. to about 150° C., more preferably from about 40° C. to about 100° C., and even more preferably from about 40° C. to about 80° C., depending on factors such as the polymerization initiation source and type of the polymerization medium.

The fluorocopolymer may be prepared by suspension polymerization. In this process, the polymerization system comprises primarily water, sometimes a buffer solution, acid scavangers, one or more initiators, and the co-monomers with mechanical agitation. The monomers can be either loaded at the beginning of the reaction or loaded continuously during the reaction and/or a combination of and initial loading with intervals of additional loading during the reaction. Agitation occurred using agitators rotated at 100-1000 rpm, more preferably from about 100-700 rpm, and even more preferably from about 300-600 rpm, depending upon factors such as the polymerization initiation source, temperature, and monomers utilized.

The fluorocopolymer may be prepared by emulsion polymerization. In this process, the polymerization system comprises primarily water, one or more emulsifiers (with surfactants), a buffer solution, one or more initiators, and the co-monomers. The monomers can be either loaded at the beginning of the reaction or loaded continuously with a high-pressure pump during the reaction.

Non-limiting examples of surfactants suitable for the preparation of the fluorocopolymer include fluorosurfactants, hydrocarbon surfactants, such as sodium octyl sulfonate, sodium dodecylsulfonates, sodium decyl sulfate, sodium caprylate, sodium stearate, and nonylphenolpoly(ethylene oxide). In a preferred embodiment of the present invention, a fluorosurfactant or perfluorinated carboxylic acid is used, such as ammonium perfluorooctonoate.

Non-limiting examples of buffer solutions suitable for the preparation of the fluorocopolymers include disodium hydrogen phosphate, trisodium phosphate, and ammonium carbonate.

The copolymerization may be conducted in any of the aqueous emulsion solutions commonly used in the art. Such aqueous emulsion solutions may include, but are not limited to, degassed deionized water, buffer compounds (such as, but not limited to, Na₂HPO₄/NaH₂PO₄), and an emulsifier (such as, but not limited to, C₅F₁₁CO₂NH₄, CH₃(CH₂)₁₁OSO₃Na, C₁₂H₂₅C₆H₄SO₃Na, C9H₁₉C₆H₄O (C₂H₄O)₁₀H, or the like).

After polymerization, the fluorocopolymer may be precipitated by adding electrolyte into the polymerization system. Fluorocopolymer powder is obtained after washing and drying. This method is environmentally friendly because no chlorofluorocarbons or common solvents are used.

The repeating units according to the present invention can be arranged in any form, including as random copolymers, statistical copolymers, alternating copolymers, block copolymers and graft copolymers. In preferred embodiments, the fluorocopolymers provided herein are random copolymers and no additional steps are taken to control the arrangement of the monomers in the fluorocopolymer.

### Hydrolysis

In preferred embodiment, the fluorocopolymer is at least partially hydrolyzed to convert ester groups on the fluorocopolymer to the alcohol group. The hydrolysis may be carried out by any means known in the art, for example for the hydrolysis of poly vinyl acetate. The hydrolysis may be carried out in the presence of an acid or a base. An aqueous solvent may be used, optionally with a co-solvent such as a polar aprotic solvent. Preferred conditions include hydrolysis in methanol in the presence of catalytic amounts of sodium methoxide at 40-50° C.

### Polymer Properties

The present invention provides fluorocopolymers as described in the previous paragraphs wherein the polymer has a number average molecular weight of greater than about 6,000 Daltons, or greater than about 20,000 Daltons, or greater than about 30,000 Daltons, or greater than about 50,000 Daltons. The fluorocopolymers as described in the previous paragraphs may have a number average molecular weight of less than 500,000 Daltons, or less than about 300,000 Daltons, or less than 150,000 Daltons, or less than 100,000 Daltons. The molecular weight is determined on an Agilent Technologies PL-GPC 220 High Temperature Chromatograph with a PLgel Mixed-C column at 40° C. with THF as the eluant. The method is described in MODERN SIZE-EXCLUSION LIQUID CHROMATOGRAPHY Practice of Gel Permeation and Gel Filtration Chromatography SECOND EDITION Andre M. Striegel, Wallace W. Yau, Joseph J. Kirkland and Donald D. Bly, 2009 by John Wiley & Sons, Inc.

According to preferred aspects, the present invention provides fluorocopolymers as described in the previous paragraphs wherein the fluorine content of the fluorocopolymer is greater than about 10% by weight of the fluorocopolymer, greater than 40% by weight, or greater than 50% by weight. The fluorocopolymers as described in the previous paragraphs has a fluorine content of less than about 70% by weight of the fluorocopolymer. The fluorine content of the fluorocopolymer as described in the previous paragraphs is in the range from about 10% to about 70% by weight of the fluorocopolymer; from about 20% to about 65% by weight of the fluorocopolymer, or from about 30% to about 65% by weight of the fluorocopolymer.

### Additives

Depending on the use, the coating solution of the present invention may include one or more additives. The additives may be provided to improve one or more characteristics of the fluorocopolymer coating composition.

In preferred embodiments, alkali metal oxides and/or alkali earth metal oxides are added to the hydrolyzed fluorocopolymer or the coating composition. The metal oxides include aluminum oxide, magnesium hydroxide, iron oxide, zinc oxide and combinations there of. The metal oxide may be added in an amount of between 0.1% to 10% by weight. The metal oxide is bound by the hydroxyl groups on the fluorocopolymer from the hydrolyzed esters, and provide a wire coating with improved flame resistance.

By way of non-limiting example, additives may be provided to assist with anti-corrosion, with hydrophobicity, substrate bonding or adhesion, or the like. Suitable additives may include, but are not limited to, high- or low-temperature additives, lubricants, tackifiers, adhesion promoters, film-formers, thickeners, processing aids, stabilizers, impact modifiers, viscosity modifiers, or any other additive that improves one or more of the properties herein or which is otherwise compatible with the fluorocopolymers. One of skill in the art will appreciate, however, that the present invention is not limited to such additives generally or with each composition and that these or any composition of the present invention may be modified to include one or more additives otherwise known or may be useful for the purpose provided. Typically, the final coating comprises no more than about 25 wt. % of the additives, or no more than about 20 wt. %, or no more than 15 about wt. %, or no more than about 10 wt. %, or no more than about 5 wt. %, or no more than about 1 wt. % of the additives.

### Coupling/Cross-Linking Agents

The fluorocopolymers can be cross-linked to improve the mechanical properties of the wire or cable insulation. Cross-linking the fluorocopolymer can enhances its mechanical properties. This can enhance resistance to abrasion and cutting, in addition to improving flammability. Cross-linking may be accomplished by incorporating a cross-linking agent into the fluorocopolymer before or after the extrusion of the insulation, followed by irradiation where appropriate.

Preferred cross-linking agents include compounds such as triallyl cyanurate, triallyl isocyanurate (TAIC), triallyl trimellitate, triallyl trimesate, and tetraallyl pyromellitate. The wire insulation may be fabricated by melt extrusion and immersed in a solution of the cross-linking agent at elevated temperatures. Cross-linking agent content should be preferably in the range of 0.5-15% by weight. The “imbibed” article such as wire insulation is irradiated to a dose of 2-30 Mrad.

### Cable Coating

The insulated cable comprises a core wire such as a cable and an insulating material formed from a resin of the fluorocopolymer coating the core wire. In general, the insulated cable is manufactured by extrusion coating in which molten resin is extruded in the shape of a tube, drawn down by inserting a core wire through the center portion of the resin tube in its axial direction, and the core wire coated with the resin is then taken up. The term “draw-down” as used herein means extending a molten resin extruded from a die having an opening of relatively large sectional area to its final intended dimensions. The draw-down is characterized by a draw-down ratio (DDR), which is the ratio of the sectional area of the opening of the die to the sectional area of the insulated material of the final product. In general, the draw-down ratio is suitably from 50 to 150.

### Coating/Film Properties

The fluorocopolymers for use in the coatings compositions may provide the advantage of improved adhesion to electronic components, while also providing one or more of a low dielectric constant, a low loss tangent for high frequency electronics, low refractive index, good thermal resistance, and good flame resistance.

The coating comprising the fluorocopolymers as described herein preferably have at least one, and more preferably each of the following properties.

The coating comprising the fluorocopolymers has a low dielectric constant. Preferably, the dielectric constant is less than about 3.0 as measured according to ASTM D150 Standard Test Methods for AC Loss Characteristics and Permittivity (Dielectric Constant) of Solid Electrical Insulation.

The coating comprising the fluorocopolymers also has a low loss tangent for high frequency electronics as measured by ICP-TM-650 method 2.5.5.9. The loss tangent is preferably less than 0.04 and more preferred less than 0.009. This procedure outlines a test method to determine the permittivity (dielectric constant or E'r) and loss tangent (dissipation factor or Tan δ) of printed wiring materials at various frequencies (from 1 MHz to 1.5 GHz) using a single test fixture for the measurement. The permittivity and loss tangent are measured using a narrow sweep of frequency around the target or desired frequency. The test method is built around the capability of currently available materials analyzers, which use a capacitance method to determine permittivity.

The coating comprising the fluorocopolymer may also have strong adhesion between the coating and the underlying substrate. In embodiments where the substrate is wire, and particularly, a copper wire, the fluorocopolymer coating preferably has an improved adhesion relative to other fluorinated coatings. The fluorocopolymer coating may have an adhesion to wire of at least 6.30 MPa, as measured by ASTM D-1002: copper shear adhesion at break. ASTM D1002-10 Standard Test Method for Apparent Shear Strength of Single-Lap-Joint Adhesively Bonded Metal Specimens by Tension Loading (Metal-to-Metal).

The coating comprising the fluorocopolymer has good thermal resistance. The thermal resistance can be measure as a comparison of the degradation rate (weight percent per hour) as a function of temperature by thermogravimetric analysis (TGA). Preferably, the percent weight loss per hour is less than about 0.1%, and more preferably less than about 0.05%, when measured at temperatures from 250 to 550° C.

The fluorocopolymer as based on ash test using Dry Ashing in Muffle Furnace technique (ASTM 5630) have total ash of less than 1%, more preferably less than 0.5%

The coating comprising the fluorocopolymer has good flame resistance. The flame resistance is measured by the Limiting Oxygen Index (LOI) according to ASTM D2863, and preferably has a value of 95% or higher.

### Aspects of the Invention

Aspect 1A: A fluorocopolymer formed by copolymerization of the monomers comprising (a) and (b):
(a) one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F; and
(b) one or more co-monomers selected from vinyl esters, one or more halogen-containing, non-cyclic olefin co-monomers having from two (2) to six (6) carbon atoms (hereinafter for convenience referred to as “C2-C6”) different than monomer (a), and combinations of two or more of these.
   Aspect 1B: A fluorocopolymer formed by copolymerization of the monomers comprising (a) and (b):
(a) one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F; and
(b) one or more co-monomers selected from vinyl esters, C2 halogen containing co-monomer according to the formula:

R¹R²C═CR¹R²
wherein R¹ and R² are each independently selected from Cl, H, or F, provided that at least one Cl or F is present on the molecule, and combinations of two or more of these.
   Aspect 1C: A fluorocopolymer formed by copolymerization of the monomers comprising (a) and (b):
(a) one or more hydrofluoroolefin represented by the formula I:

(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F; and
(b) one or more co-monomers selected from vinyl esters, C2 halogen containing co-monomer according to the formula:

H₂C═CR¹R²
wherein R¹ and R² are each independently selected from Cl, H, or F, provided that

at least one Cl or F is present on the molecule, and combinations of two or more of these. As used hereinafter, the term Aspect 1 or a phrase including Aspect 1 means and is understood to mean any of Aspect 1A, Aspect 1B and Aspect of 1C.

Aspect 2: The fluorocopolymer according to Aspect 1, wherein the hydrofluoroolefin is represented by the formula Ia:

(CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F.
   Aspect 3: The fluorocopolymer according to Aspect 1, wherein the hydrofluoroolefin is represented by the formula Ib:

(CF₃)(R^{1b})C═C(R^{2b})(R^{3b})
wherein:
R^{1b} is selected from the group consisting of H and F;
R^{2b} is selected from the group consisting of H and F; and
R^{3b} is H.
   Aspect 4: The fluorocopolymer according to Aspect 1, wherein the hydrofluoroolefin is represented by the formula Ic:

(CF₃)(R^{1c})C═C(R^{2c})(R^{3c})
wherein:
R^{1d} is selected from the group consisting of H, F and Cl;
R^{2c} is CF₃; and
R^{3c} is selected from the group consisting of H and F.
   Aspect 5: The fluorocopolymer according to Aspect 1, wherein the hydrofluoroolefin is represented by the formula Id:

(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is C1.
   Aspect 6: The fluorocopolymer according to any one of Aspects 1 to 5, wherein the hydrofluoroolefin is a hydrofluoropropene.
   Aspect 7: The fluorocopolymer according to any one of Aspects 1 or 2, wherein the hydrofluoroolefin is a hydrofluorobutene.
   Aspect 8: The fluorocopolymer according to any one of Aspects 1 to 5, wherein the hydrofluoroolefin is selected from the group consisting of 1234yf, 1234ze, 1233zd, 1233xf, 1336mzzm, 1336mcfq, 1225ye, 1225zc and 1224yd.
   Aspect 9: The fluorocopolymer according to Aspect 1, wherein the hydrofluoroolefin is 1234yf.
   Aspect 10: The fluorocopolymer according to Aspect 1, wherein the hydrofluoroolefin is 1234ze.
   Aspect 11: The fluorocopolymer according to Aspect 10, wherein the 1234ze is trans-1234ze.
   Aspect 12: The fluorocopolymer according to Aspect 10, wherein the 1234ze is 95% trans-1234ze by weight based on the total 1234ze isomers.
   Aspect 13: The fluorocopolymer according to Aspect 10, wherein the 1234ze is 99% trans-1234ze by weight based on the total 1234ze isomers.
   Aspect 14: The fluorocopolymer according to Aspect 10, wherein the 1234ze is about 70% trans-1234ze and about 30% cis-1234ze by weight based on the total 1234ze isomers.
   Aspect 15: The fluorocopolymer according to Aspect 10, wherein the 1234ze is cis-1234ze.
   Aspect 16: The fluorocopolymer according to Aspect 1, wherein the hydrofluoroolefin is 1233zd.
   Aspect 17: The fluorocopolymer according to Aspect 16, wherein the 1233zd is trans-1233zd.
   Aspect 18: The fluorocopolymer according to Aspect 1, wherein the hydrofluoroolefin is 1233xf.
   Aspect 19: The fluorocopolymer according to Aspect 1, wherein the hydrofluoroolefin is 1336mzzm.
   Aspect 20: The fluorocopolymer according to Aspect 19, wherein the 1336mzzm is cis-1336mzzm.
   Aspect 21: The fluorocopolymer according to Aspect 1, wherein the hydrofluoroolefin is 1336mcfq.
   Aspect 22: The fluorocopolymer according to Aspect 1, wherein the hydrofluoroolefin is 1225ye,
   Aspect 23: The fluorocopolymer according to Aspect 1, wherein the hydrofluoroolefin is 1225zc.
   Aspect 24: The fluorocopolymer according to Aspect 1, wherein the hydrofluoroolefin is 1224yd.
   Aspect 25: The fluorocopolymer according to any one of Aspects 1 to 24, wherein a vinyl ester is present and has the formula II:

(R⁵)₂C═C(R⁶)(O—C═O—R⁷)

wherein each R⁵ is independently selected from H and methyl, and each R⁵ is preferably H, R⁶ is selected from H and methyl, and R⁷ is selected from C₁ to C6 branched or straight-chain alkyl, and R⁷ is preferably C₁ to C₃ alkyl.
Aspect 26: The fluorocopolymer according to Aspect 25, wherein each R⁵ is H, and R⁷ is C₁ to C₃ alkyl.
Aspect 27: The fluorocopolymer according to any one of Aspects 1 to 24, wherein a vinyl ester is present and has the formula IIa:

H₂C═CH-O—(C═O)—R⁸

wherein each R⁸ is selected from C₁ to C6 branched or straight-chain alkyl, and R⁸ is preferably C₁ to C₃ alkyl.
Aspect 28: The fluorocopolymer according to any one of Aspects 1 to 27, wherein a vinyl ester is present and is vinyl acetate.
Aspect 29: The fluorocopolymer according to any one of Aspects 1 to 27, wherein the vinyl ester is present and is vinyl propionate.
Aspect 30: The fluorocopolymer according to any one of Aspects 1 to 27, wherein the vinyl ester is present and is vinyl butyrate.
Aspect 31: The fluorocopolymer according to any one of Aspects 1 to 24, wherein the vinyl ester is present and is vinyl iso-butyrate.
Aspect 32: The fluorocopolymer according to any one of Aspects 1 to 31, wherein the one or more halogen-containing non-cyclic C2-C6 olefin co-monomers is present and is selected from the group consisting of vinyl fluoride (VF), vinylidene fluoride (VDF), trifluoroethylene (TrFE), tetrafluoroethylene (TFE), chlorotrifluoroethylene (CTFE), and mixtures thereof.
Aspect 33: The fluorocopolymer according to any one of Aspects 1 to 32, wherein the one or more halogen-containing non-cyclic C2-C6 olefin co-monomers is present and is vinyl fluoride (VF).
Aspect 34: The fluorocopolymer according to any one of Aspects 1 to 32, wherein the one or more halogen-containing non-cyclic C2-C6 olefin co-monomers is present and is vinylidene fluoride (VDF).
Aspect 35: The fluorocopolymer according to any one of Aspects 1 to 32, wherein the halogen-containing co-monomer(s) is trifluoroethylene (TrFE).
Aspect 36: The fluorocopolymer according to any one of Aspects 1 to 32, wherein the one or more halogen-containing non-cyclic C2-C6 olefin co-monomers is present and is tetrafluoroethylene (TFE).
Aspect 37: The fluorocopolymer according to any one of Aspects 1 to 32, wherein the one or more halogen-containing non-cyclic C2-C6 olefin co-monomers is present and is chlorotrifluoroethylene (CTFE).
Aspect 38: The fluorocopolymer according to any one of Aspects 1 to 37, wherein the vinyl ester co-monomer is present and comprises from about 5 to about 60 mol % of the monomers of the fluorocopolymer.
Aspect 39. The fluorocopolymer according to any one of Aspects 1 to 37, wherein the one or more halogen-containing non-cyclic C2-C6 olefin co-monomers is present and comprises from about 10 to about 90 mol % of the monomers of the fluorocopolymer Aspect 40: The fluorocopolymer according to any one of Aspects 1 to 37, wherein the vinyl ester co-monomer is present and comprises from about 5 to about 60 mol % of the monomers of the fluorocopolymer.
Aspect 41: The fluorocopolymer according to any one of Aspects 1 to 37, wherein the vinyl ester co-monomer is present and comprises from about 5 to about 60 mol % of the monomers of the fluorocopolymer.
Aspect 42: The fluorocopolymer according to any one of Aspects 1 to 37, wherein the vinyl ester co-monomer is present and comprises from about 5 to about 50 mol % of the monomers of the fluorocopolymer.
Aspect 43: The fluorocopolymer according to any one of Aspects 1 to 37, wherein the vinyl ester co-monomer is present and comprises from about 5 to about 35 mol % of the monomers of the fluorocopolymer.
Aspect 44: The fluorocopolymer according to any one of Aspects 1 to 37, wherein the vinyl ester co-monomer is present and comprises from about 5 to about 30 mol % of the monomers of the fluorocopolymer.
Aspect 45: The fluorocopolymer according to any one of Aspects 1 to 37, wherein the vinyl ester co-monomer is present and comprises from about 10 to about 40 mol % of the monomers of the fluorocopolymer.
Aspect 46: The fluorocopolymer according to any one of Aspects 1 to 37, wherein the vinyl ester co-monomer is present and comprises from about 5 to about 25 mol % of the monomers of the fluorocopolymer.
Aspect 47: The fluorocopolymer according to any one of Aspects 1 to 37, wherein the vinyl ester co-monomer is present and comprises from about 5 to about 20 mol % of the monomers of the fluorocopolymer.
Aspect 48: The fluorocopolymer according to any one of Aspects 1 to 46, wherein the hydrofluoroolefin monomers comprise from about 40 to about 95 mol % of the monomers of the fluorocopolymer,
Aspect 49: The fluorocopolymer according to any one of Aspects 1 to 46, wherein the hydrofluoroolefin monomers comprise from about 40 to about 90 mol % of the monomers of the fluorocopolymer.
Aspect 50: The fluorocopolymer according to any one of Aspects 1 to 46, wherein the hydrofluoroolefin monomers comprise from about 50 to about 95 mol % of the monomers of the fluorocopolymer.
Aspect 51: The fluorocopolymer according to any one of Aspects 1 to 46, wherein the hydrofluoroolefin monomer comprise from about 55 to about 90 mol % of the monomers of the fluorocopolymer.
Aspect 52: The fluorocopolymer according to any one of Aspects 1 to 46, wherein the hydrofluoroolefin monomers comprise from about 60 to about 90 mol % of the monomers of the fluorocopolymer.
Aspect 53: The fluorocopolymer according to any one of Aspects 1 to 46, wherein the hydrofluoroolefin monomers comprise from about 65 to about 95 mol % of the monomers of the fluorocopolymer.
Aspect 54: The fluorocopolymer according to any one of Aspects 1 to 46, wherein the hydrofluoroolefin monomers comprise from about 70 to about 90 mol % of the monomers of the fluorocopolymer.
Aspect 55: The fluorocopolymer according to any one of Aspects 1 to 46, wherein the hydrofluoroolefin monomers comprise from about 70 to about 85 mol % of the monomers of the fluorocopolymer.
Aspect 56: The fluorocopolymer according to any one of Aspects 1 to 46, wherein the hydrofluoroolefin monomers comprise from about 75 to about 95 mol % of the monomers of the fluoro-copolymer.
Aspect 57: The fluorocopolymer according to any one of Aspects 1 to 46, wherein the hydrofluoroolefin monomers comprise from about 80 to about 95 mol % of the monomers of the fluoro-copolymer.
Aspect 58: The fluorocopolymer according to any one of Aspects 1 to 46, wherein the hydrofluoroolefin monomers comprise from about 15 to about 85 mol % of the monomers of the fluorocopolymer.
Aspect 59: The fluorocopolymer according to any one of Aspects 1 to 46, wherein the hydrofluoroolefin monomers comprise from about 20 to about 75 mol % of the monomers of the fluorocopolymer.
Aspect 60: The fluorocopolymer according to any one of Aspects 1 to 46, wherein the hydrofluoroolefin monomers comprise from about 30 to about 65 mol % of the monomers of the fluorocopolymer.
Aspect 61: The fluorocopolymer according to any one of Aspects 1 to 46, wherein the hydrofluoroolefin monomers comprise from about 40 to about 55 mol % of the monomers of the fluoro-copolymer.
Aspect 62: The fluorocopolymer according to any one of Aspects 1 to 46, wherein the hydrofluoroolefin monomers comprise from about 5 to about 60 mol % of the monomers of the fluorocopolymer.
Aspect 63: The fluorocopolymer according to any one of Aspects 1 to 46, wherein the hydrofluoroolefin monomers comprise from about 5 to about 55 mol % of the monomers of the fluorocopolymer.
Aspect 64: The fluorocopolymer according to any one of Aspects 1 to 46, wherein the hydrofluoroolefin monomers comprise from about 10 to about 50 mol % of the monomers of the fluorocopolymer.
Aspect 65: The fluorocopolymer according to any one of Aspects 1 to 46, wherein the hydrofluoroolefin monomers comprise from about 5 to about 40 mol % of the monomers of the fluorocopolymer.
Aspect 66: The fluorocopolymer according to any one of Aspects 1 to 46, wherein the hydrofluoroolefin monomers comprise from about 10 to about 40 mol % of the monomers of the fluorocopolymer.
Aspect 67: The fluorocopolymer according to any one of Aspects 1 to 46, wherein the hydrofluoroolefin monomers comprise from about 5 to about 35 mol % of the monomers of the fluorocopolymer.
Aspect 68: The fluorocopolymer according to any one of Aspects 1 to 46, wherein the hydrofluoroolefin monomers comprise from about 10 to about 35 mol % of the monomers of the fluoro-copolymer.
Aspect 69: The fluorocopolymer according to any one of Aspects 1 to 67, wherein the, C2-C6 non-cyclic olefin co-monomer is present and is selected from 1, 1-dichloroethene (also known as vinylidene chloride); 1, 1-dichloroethene in both its cis and trans forms (also known as cis- and trans-DCE); chlorotrifluoroethylene; tetrafluoroethene; 1,1-dichlorotetrafluoropropene; octofluoro-2-butene; 1,2,3,3,4,4-hexafluoro-1-butene; 2,3,3,4,4,4-hexafluoro-1-butene; 1,1,1,4,4,4,-hexafluoro-2-butene; 1,2,3,3,3-pentafluorpropene; 1,1,3,3,3-pentafluorpropene; 1,3,3,3-tetrafluoroprop-1-ene; 1,2-dichloroethylene; 1-chloro-3,3,3-trifluoropropene; 2,3-dichloro-1,1,1,4,4,4-hexafluoro-2-butene; 2-chloro-1,1,1,4,4,4-hexafluor-2-butene; (e)-1,1,1,3-tetrafluoro-2-butene; 4,4,4-trifluoro-1-butene; (z)-1,1,1,3-trifluoro-1-butene; 1,4-dichloro-hexafluoro-2-butene; 2,4,4,4-tetrafluoro-1-butene; (e/z)-2-chloroheptafluoro-2-butene; 1,1,1,2,4,4,4-heptafluoro-2-butene; 4-chloro-1,1,1,2-trifluoro-1-butene; 2-chloro-1,1,1,3-tetrafluoro-2-butene; 1,1,1-trifluoro-2-butene; 2,3,3,4,4,4,-hexafluoro-1-butene; (e)-2-chloro-1,1,1,4,4,4-hexafluoro-2-butene; (z)-2-chloro-1,1,1,4,4,4-hexafluoro-2-butene; octofluoro-1-butene; 4-fluoro-1-butene; trans-1,4-dichloro-2-butene; 3-chloro-1-butene; 2,3-dichlorohexafluorobutene-2; hexafluoroisobutene; 1,1-difluorobutene; 3,3,4,4,4-pentafluorobutene-1; 1,1,4,4,4-pentafluorobutene-1; 3,3,4,4,5,5,5-heptafluoro-1-pentene; 2H-nonafluoro-2-pentene; (e)-2H, 3H-octafluoro-2-pentene; 2H,3H-otacofuoro-2-pentene; cis-2H-nonafluoro-2-pentene; perfluoropentene-2; 4,4,5,5,6,6,6-heptafluoro-2-hexane; 2,4-dichloro-1,1,1,6,6,6-hexafluoro-2-hexene; 2-chloro-3,3,4,4,5,5,6,6,6-nonafluoro-1-hexene; perfluorohexene-2; perfluorohexene-1; and 1H, 1H, 2H-perfluorohexene.
Aspect 70: The fluorocopolymer according to any one of Aspects 1 to 67, wherein the C2-C6 non-cyclic olefin co-monomer is present and comprises from about 40 to about 90 mol % of the monomers of the fluorocopolymer.
Aspect 71: The fluorocopolymer according to any one of Aspects 1 to 67, wherein the C2-C6 non-cyclic olefin co-monomer is present and comprise from about 50 to about 90 mol % of the monomers of the fluorocopolymer.
Aspect 72: The fluorocopolymer according to any one of Aspects 1 to 67, wherein the C2-C6 non-cyclic olefin co-monomer is present and comprise from about 55 to about 90 mol % of the monomers of the fluorocopolymer.
Aspect 73: The fluorocopolymer according to any one of Aspects 1 to 67, wherein the C2-C6 non-cyclic olefin co-monomer is present and comprise from about 60 to about 90 mol % of the monomers of the fluorocopolymer.
Aspect 74: The fluorocopolymer according to any one of Aspects 1 to 67, wherein the C2-C6 non-cyclic olefin co-monomer is present and comprise from about 70 to about 90 mol % of the monomers of the fluorocopolymer.
Aspect 75: The fluorocopolymer according to any one of Aspects 1 to 67, wherein the C2-C6 non-cyclic olefin co-monomer is present and comprise from about 15 to about 85 mol % of the monomers of the fluorocopolymer.
Aspect 76: The fluorocopolymer according to any one of Aspects 1 to 67, wherein the C2-C6 non-cyclic olefin co-monomer is present and comprise from about 20 to about 75 mol % of the monomers of the fluorocopolymer.
Aspect 77: The fluorocopolymer according to any one of Aspects 1 to 67, wherein the C2-C6 non-cyclic olefin co-monomer is present and comprise from about 20 to about 75 mol % of the monomers of the fluorocopolymer.
Aspect 78: The fluorocopolymer according to any one of Aspects 1 to 67, wherein the C2-C6 non-cyclic olefin co-monomer is present and comprise from about 30 to about 65 mol % of the monomers of the fluorocopolymer.
Aspect 79: The fluorocopolymer according to any one of Aspects 1 to 67, wherein the C2-C6 non-cyclic olefin co-monomer is present and comprise from about 40 to about 55 mol % of the monomers of the fluoro-copolymer.
Aspect 80: The fluorocopolymer according to any one of Aspects 1 to 67, wherein the C2-C6 non-cyclic olefin co-monomer is present and comprise from about 5 to about 60 mol % of the monomers of the fluorocopolymer.
Aspect 81: The fluorocopolymer according to any one of Aspects 1 to 67, wherein the C2-C6 non-cyclic olefin co-monomer is present and comprise from about 5 to about 55 mol % of the monomers of the fluorocopolymer.
Aspect 82: The fluorocopolymer according to any one of Aspects 1 to 67, wherein the fluoroethylene co-monomers comprise from about 10 to about 50 mol % of the monomers of the fluorocopolymer.
Aspect 83: The fluorocopolymer according to any one of Aspects 1 to 67, wherein the fluoroethylene co-monomers comprise from about 5 to about 40 mol % of the monomers of the fluorocopolymer.
Aspect 84: The fluorocopolymer according to any one of Aspects 1 to 67, wherein the C2-C6 non-cyclic olefin co-monomer is present and comprise from about 10 to about 40 mol % of the monomers of the fluorocopolymer.
Aspect 85: The fluorocopolymer according to any one of Aspects 1 to 67, wherein the C2-C6 non-cyclic olefin co-monomer is present and comprise from about 5 to about 35 mol % of the monomers of the fluorocopolymer.
Aspect 86: The fluorocopolymer according to any one of Aspects 1 to 67, wherein the C2-C6 non-cyclic olefin co-monomer is present and comprise from about 10 to about 35 mol % of the monomers of the fluoro-copolymer.
Aspect 87: The fluorocopolymer according to any one of Aspects 1 to 86, wherein the fluorocopolymer has a number average molecular weight of greater than about 5,000 Daltons Aspect 88: The fluorocopolymer according to any one of Aspects 1 to 86, wherein the fluorocopolymer has a number average molecular weight of greater than about 10,000 Daltons.
Aspect 89: The fluorocopolymer according to any one of Aspects 1 to 86, wherein the fluorocopolymer has a number average molecular weight of greater than about 30,000 Daltons.
Aspect 90: The fluorocopolymer according to any one of Aspects 1 to 86, wherein the fluorocopolymer has a number average molecular weight of greater than about 50,000 Daltons.
Aspect 91: The fluorocopolymer according to any one of Aspects 1 to 90, wherein the fluorocopolymer has a number average molecular weight of less than 500,000 Daltons.
Aspect 92: The fluorocopolymer according to any one of Aspects 1 to 90, wherein the fluorocopolymer has a number average molecular weight of less than about 300,000 Daltons.
Aspect 93: The fluorocopolymer according to any one of Aspects 1 to 90, wherein the fluorocopolymer has a number average molecular weight of less than 150,000 Daltons.
Aspect 94: The fluorocopolymer according to any one of Aspects 1 to 90, wherein the fluorocopolymer has a number average molecular weight of less than 100,000 Daltons.
Aspect 95: The fluorocopolymer according to any one of Aspects 1 to 94, wherein the fluorocopolymer has a fluorine content greater than about 5% by weight of the fluorocopolymer.
Aspect 96: The fluorocopolymer according to any one of Aspects 1 to 94, wherein the fluorocopolymer has a fluorine content greater than about 10% by weight of the fluorocopolymer.
Aspect 97: The fluorocopolymer according to any one of Aspects 1 to 94, wherein the fluorocopolymer has a fluorine content greater than about 20% by weight of the fluorocopolymer.
Aspect 98: The fluorocopolymer according to any one of Aspects 1 to 97, wherein the fluorocopolymer has a fluorine content greater less than about 35% by weight of the fluorocopolymer.
Aspect 99: The fluorocopolymer according to any one of Aspects 1 to 98, wherein the ester groups, when present, have been hydrolyzed to the hydroxyl group.
Aspect 100: A wire or cable coating, comprising the fluorocopolymer according to any one of Aspects 1 to 98.
Aspect 101: A wire or cable coating, comprising the fluorocopolymer according to any one of Aspects 1 to 98, and aluminum oxide.
Aspect 102: A wire or cable coating, comprising the fluorocopolymer according to any one of Aspects 1 to 98, and magnesium hydroxide.
Aspect 103: The wire or cable coating according to any one of Aspects 99 to 102, comprising the fluorocopolymer according to any one of aspects 1 to 98, wherein the coating has a dielectric constant is less than about 5.
Aspect 104: The wire or cable coating according to any one of aspects 99 to 103, comprising the fluorocopolymer according to any one of Aspects 1 to 98, wherein the coating has a loss tangent less than 0.02.
Aspect 105: The wire or cable coating according to any one of Aspects 99 to 104, comprising the fluorocopolymer according to any one of aspects 1 to 98, wherein the coating has an adhesion to wire of at least 6.30 MPa.
Aspect 106: The wire or cable coating according to any one of Aspects 99 to 105, comprising the fluorocopolymer according to any one of Aspects 1 to 98, wherein the coating has a flame resistance of 95% or higher as measured by the Limiting Oxygen Index (LOI) according to ASTM D2863.
Aspect 107. The fluoropolymer, according to any of the aspects 1 to 24, wherein the halogen-containing co monomer is present and comprises vinylidene fluoride VDF.
Aspect 108. The fluoropolymer, according to any of the aspects 1-24, wherein the C2-C6 non-cyclic olefin is present and comprises vinyl chloride (VC).
Aspect 109. The fluoropolymer, according to any of the aspects 1-24, wherein the C2-C6 non-cyclic olefin co-monomer is present and comprises vinyl fluoride (VF).
Aspect 110. The fluoropolymer, according to any of the aspects 1-24, wherein the C2-C6 non-cyclic olefin co-monomer is present and comprises trifluoroethylene (TrFE).
Aspect 111. The fluoropolymer, according to any of the aspects 1-24, wherein the C2-C6 non-cyclic olefin co-monomer is present and comprises tetrafluoroethylene (TFE).
Aspect 112. The fluoropolymer, according to any of the aspects 1-24, wherein the C2-C6 non-cyclic olefin co-monomer is present and comprises chlorotrifluoroethylene (CTFE).
Aspect 113. The fluoropolymer, according to any of the aspects 1-24, wherein the C2-C6 non-cyclic olefin co-monomer is present and comprises chlorotrifluoroethylene (CTFE).
Aspect 114. The fluoropolymer, according to any of the aspects 1-24, wherein the C2-C6 non-cyclic olefin co-monomer is present and comprises trans-DCE.
Aspect 115. The fluoropolymer, according to any of the aspects 1-24, wherein the C2-C6 non-cyclic olefin co-monomer is present and comprises cis-DCE.

### EXAMPLES

### Example A: Polymerization of Monomers from Tables 1-2

In a series of experiments testing each of the HFO/co-monomer combinations disclosed in Tables 1 and 2, a 400 mL Hastelloy C autoclave is charged with butyl acetate (180 mL), 0.05 mole azobisisobutyronitrile (AIBN) and 0.5 mole of the selected co-monomer from each of Tables 1 and 2 and cooled, evacuated and nitrogen flushed. Next, 0.25 mole of the selected HFO associated with the co-monomer chosen from each of Tables 1 and 2 is charged to the autoclave. Vigorous stirring is started and continued throughout the run. The reactor is heated to 70° C. causing the pressure in the autoclave to increase. Stirring and heating are stopped after pressure has decreased about 40%. This gives a polymer emulsion that is concentrated under vacuum. The resulting polymer is collected and subjected to GPC, NMR and DSC analysis and found to be acceptable.

### Example B. Polymerization of Monomers from Tables 3-8

In a series of experiments testing each of the HFO/co-monomer combinations disclosed in each of Tables 3 through 8, a 400 mL Hastelloy C autoclave is charged with butyl acetate (180 mL), 0.05 mole of azobisisobutyronitrile (AIBN) and 0.5 mole of the first of the selected co-monomer from each of Tables 3 through 8 and cooled, evacuated and nitrogen flushed. Next, 0.25 mole of the second of the selected co-monomer from Table 3 and 0.25 mole of the hydrofluoroolefin (HFO) from each of Tables 3 through 8 are then charged to the autoclave. Vigorous stirring is started and continued throughout the run. The reactor is heated to 70° C. causing the pressure in the autoclave to increase. Stirring and heating are stopped after the pressure has decreased 40%. This gives a polymer emulsion that is concentrated under vacuum. The resulting polymer is collected and subjected to GPC, NMR and DSC analysis and found to be acceptable.

### Example 1—Suspension Polymerization

200 mL of deioinized water with stirring and nitrogen sparging was provided. To this deionized water 0.52 g of (NH₄)₂S₂O₈ and 7.0 g of vinyl propionate were added to form an aqueous solution. The resulting aqueous solution was degassed and transferred into an evacuated 600 mL autoclave reactor. The reactor was cooled with dry ice and the aqueous solution inside, stirred at 100 rpm. When the internal temperature of the aqueous solution decreases to about −4° C., 72.0 g of 1234yf was transferred into the reactor. The dry ice cooling was removed. The reactor was slowly warmed up to ambient while the stir rate increased to 500 rpm. The autoclave reactor was slowly heated over a 15 minute period to 65° C.

After from about 24 to about 48 hours, the heating was stopped. Residual pressure in the autoclave was released and the reactor cooled to room temperature. The resulting polymer was isolated by filtration, the solid washed with deionized water until a neutral pH was achieved. Stirring and heating were stopped about 24 to about 48 hours after the pressure had decreased. After drying in vacuum oven (100 mmHg) at 60° C. overnight, the dried copolymer was subjected to GPC, NMR, elemental, TGA, and DSC analysis. Table 9A below reports on the most relevant results of this analysis:

TABLE 9A

| | | Theoretical | | | | | |
|---|---|---|---|---|---|---|---|
| | | Monomer feed | | | | GPC- | |
| | Monomer | ratio (Mole | % HFO | Elemental | Tg | SEC | TGA |
| HFO | 1 | HFO:comonomer) | mole | Analysis | (oC) | (Daltons) | Results |
| 1234yf | Vinyl | 90:10 | 82.5 | 50.78% F, | 27 | | >99.5% |
| | butyrate | | | 37.35% C, | | | reamining |
| | | | | 2.73% H, | | | after |
| | | | | 0.07% N, | | | 150° C. |
| 1234yf | Vinyl | 70:30 | 53.6 | 46.01% C, | 13 | Mn | >99.5% |
| | butyrate | | | 4.68% H, | | 78227, | reamining |
| | | | | 35.52% F, | | Mw | after |
| | | | | <0.05% N | | 288191, | 150° C. |
| | | | | | | PD 3.684 | |
| 1234yf | Vinyl | 50:50 | 1.7 | 50.72% C, | 7.5 | n/a | >99.5% |
| | butyrate | | | 5.94% H, | | | reamining |
| | | | | 0.07% N, | | | after |
| | | | | 0.89% F | | | 150° C. |
| 1234yf | Vinyl | 90:10 | 94.2 | 61.61% F, | 50 | | >99.5% |
| | propionate | | | 32.22% C, | | | reamining |
| | | | | 1.99% H, | | | after |
| | | | | 0.41% N | | | 150° C. |
| 1234yf | Vinyl | 70:30 | 49.8 | 34.68% F, | 48 | N/A | >99.5% |
| | propionate | | | 44.05% | | | reamining |
| | | | | C, 4.58% H | | | after |
| | | | | <0.05% N | | | 150° C. |
| 1234yf | Vinyl | 50:50 | 43 | 30.51% F, | 26 | n/a | >99.5% |
| | propionate | | | 46.53% | | | reamining |
| | | | | C, 4.70% H | | | after |
| | | | | <0.05% N | | | 150° C. |
| | | | | | | | >99.5% |
| | | | | | | | reamining |
| | | | | | | | after |
| | | | | | | | 150° C. |
| | | | | | | | >99.5% |
| | | | | | | | reamining |
| | | | | | | | after |
| | | | | | | | 150° C. |
| | | | | | | | >99.5% |
| | | | | | | | reamining |
| | | | | | | | after |
| | | | | | | | 150° C. |

Further examples using this same procedure are tabulated in Table 9B below, with monomer, initiator, and concentration amounts listed:

TABLE 9B

| | | | Ammonium |
|---|---|---|---|
| | Comonomer | 1234yf | persulfate |
| Comonomer | Mass (g) | Mass (g) | Mass (g) |
| Vinyl propionate | 20.3 | 54 | 0.5 |
| Vinyl Propionate | 35 | 40 | 0.52 |
| Vinyl butyrate | 7.45 | 67 | 0.48 |
| Vinyl butyrate | 38 | 38 | 0.48 |
| Vinyl butyrate | 45.45 | 106 | 0.96 |

Acceptable polymer is produced.

### Example 2—Suspension Polymerization

400 mL of deioinized water with stirring and nitrogen purging was provided, and then, Na₂HPO₄.7H₂O (1.58 g), NaH₂PO₄ (2.76 g), and FeSO₄*7H₂O (0.01 g) were added. Next, 0.34 g of (NH₄)₂S₂O₈ was added into the above aqueous solution. The resulting aqueous solution was then degassed and transferred into an evacuated 600 mL autoclave reactor. The reactor was cooled with dry ice and the aqueous solution inside, stirred at 100 rpm. Next, vinylidene fluoride (10.0 g) and 1234yf (36.0 g) were charged to the reactor and the formation of a suspension begins S₂O₅ (0.34 g) dissolved in D.I. water (10 mL) was pumped into the reactor using a syringe pump slowly. The dry ice cooling was removed. The reactor was slowly warmed to ambient temperature while the stir rate was increased to 500 rpm. The autoclave reactor is slowly heated to 55° C. After 48 hours, the heating was stopped, and the reactor is cooled to ambient temperature. Any unreacted monomers were recovered, as the pressure in the autoclave was released. The polymer mixture was filtered. The resulting precipitate was washed with deionized water until a neutral pH was achieved before being dried under vacuum at 35° C. to dryness. The dried copolymer was subjected to GPC, NMR, TGA, elemental, and DSC analysis.

Further examples using this same procedure are tabulated in Table 10 below with monomer, initiator, other additives, and concentration amounts listed:

TABLE 10

| | | | | | | FeSO₄ | |
|---|---|---|---|---|---|---|---|
| | Co- | 1234yf | Ammonium | | NaH2PO4 | *7H₂O | Na₂S₂O₅ |
| | monomer | Mass | persulfate | Na₂HPO₄•7H₂O | Mass | (Mass) | (Mass) |
| Comonomer | Mass (g) | (g) | Mass (g) | Mass (g) | (g) | (g) | (g) |
| VDF | 10 | 36 | 0.34 | 1.58 | 2.76 | 0.01 | 0 |
| Vinyl | 10 | 37 | 0.35 | 1.58 | 2.76 | 0.01 | 0 |
| chloride | | | | | | | |
| Vinyl | 8.9 | 32.5 | 0.32 | 1.58 | 2.76 | 0.01 | 0.32 |
| chloride | | | | | | | |
| Vinyl | 26.0 | 24.0 | 0.45 | 1.58 | 2.76 | 0.01 | 0 |
| chloride | | | | | | | |
| Vinyl | 26.0 | 24.0 | 0.45 | 1.58 | 2.76 | 0.01 | 0.45 |
| chloride | | | | | | | |

Illustrated molecular weights for selected polymers are listed in Table 11 below.

TABLE 11

| | 1234yf/comonomer | | % Yield | | | Mole % |
|---|---|---|---|---|---|---|
| | feed ratio (mass | Reaction | (mass | | GPC- | HFO- |
| Monomer | ratio) | Conditions | %) | Tg (° C.) | SEC | 1234yf |
| VDF | 67:33 | APS, Fe | 7 | none | Not | 24-47 |
| | | sulphate | | | soluble in | |
| | | | | | THF | |
| VDF | 67:33 | APS, Fe | 94 | 36 | Mn | 31.5 |
| | | sulphate, | | | 84475; | |
| | | SMBS | | | Mw | |
| | | | | | 134589; | |
| | | | | | PD 1.593 | |
| Vinyl | 67:33 | APS, Fe | 33 | 49 | Mn 7755; | 39-70 |
| chloride | | sulphate | | | Mw | |
| | | | | | 29220; | |
| | | | | | PD 3.768 | |
| Vinyl | 67:33 | APS, Fe | 24 | 48 | Not | 32.5 |
| chloride | | sulphate, | | | soluble in | |
| | | SMBS | | | THF | |
| Vinyl | 33:67 | APS, Fe | 53 | 42.72 | Mn | 6.7 |
| chloride | | sulphate | | | 19620; | |
| | | | | | Mw | |
| | | | | | 90530; | |
| | | | | | PD 4.614 | |
| Vinyl | 33:67 | APS, Fe | 52 | 75 | Mn | 11.8 |
| chloride | | sulphate, | | | 16665; | |
| | | SMBS | | | Mw | |
| | | | | | 73424; | |
| | | | | | PD 4.406 | |

### Example 3—Emulsion Polymerization

A 400 mL Hastelloy C autoclave is charged with distilled water (180 mL), Capstone FS-10 (5.30 g), disodium hydrogen phosphate (1.3 g) and ammonium persulfate (0.16 g), cooled, evacuated and nitrogen flushed. Vinyl acetate (21.5 g) and 1, 3, 3, 3-tetrafluoropropene (28.5 g) are then charged to the autoclave. Vigorous stirring is started and continued throughout the run to form an emulsion. The reactor is heated to 70° C. causing the pressure in the autoclave to increase. Stirring and heating are stopped 24-48 hours later after pressure has decreased. This polymer is filtered and washed with D.I. water until neutral pH has been achieved. After drying in vacuum oven (100 mmHg) at 60° C. overnight, the dried copolymer is subjected to GPC, NMR, elemental, TGA, and DSC analysis.

### Example 4—Solution Polymerization

A 400 mL Hastelloy C autoclave is charged with butyl acetate (180 mL), 8.2 g of azobisisobutyronitrile (AIBN) and 50 g of vinyl propionate and cooled, evacuated and nitrogen flushed. Next, 1, 3, 3, 3-tetrafluoropropene (28.5 g) are then charged to the autoclave. Vigorous stirring is started and continued throughout the run. The reactor is heated to 70° C. causing the pressure in the autoclave to increase. Stirring and heating are stopped 48 hours later after pressure has decreased 40%. This gives a polymer emulsion that is concentrated under vacuum. The resulting polymer is collected and subjected to GPC, NMR and DSC analysis.

### Example 5—Terpolymer—Solution Polymerization

A 400 mL Hastelloy C autoclave is charged with butyl acetate (180 mL), 8.2 g of azobisisobutyronitrile (AIBN) and 21.5 g of vinyl acetate and cooled, evacuated and nitrogen flushed. Next, 1, 3, 3, 3-tetrafluoropropene (28.5 g) and CTFE (29 g) are then charged to the autoclave. Vigorous stirring is started and continued throughout the run. The reactor is heated to 70° C. causing the pressure in the autoclave to increase. Stirring and heating are stopped 48 hours later after pressure has decreased 40%. This gives a polymer emulsion that is concentrated under vacuum. The resulting polymer is collected and subjected to GPC, NMR and DSC analysis.

### Example 6—Terpolymer—Solution Polymerization

A 400 mL Hastelloy C autoclave is charged with butyl acetate (180 mL), 8.2 g of azobisisobutyronitrile (AIBN) and 25 g of vinyl propionate and cooled, evacuated and nitrogen flushed. Next, 1, 3, 3, 3-tetrafluoropropene (28.5 g) and TFE (25 g) are then charged to the autoclave. Vigorous stirring is started and continued throughout the run. The reactor is heated to 70° C. causing the pressure in the autoclave to increase. Stirring and heating are stopped 48 hours later after pressure has decreased 40%. This gives a polymer emulsion that is concentrated under vacuum. The resulting polymer is collected and subjected to GPC, NMR and DSC analysis.

### Example 7—Wire Coating

The fluoropolymer from Example 1 was mixed with 60 wt. % TiO₂ (Du Pont R-101). The ingredients were dry blended, melt blended in an extruder, and then extruded as a 127 micrometer coating on to 1.3 mm solid bare copper wire (AWG 16). The resultant cable was cooled. The Thickness of the fluoropolymer insulation was re-measured. An acceptable coating wire is formed having properties suitable for use in electronics and data communication, particularly for high frequency data transmission.

### Comparative Example 8C

For the purposes of comparison to the copolymers made according to the present invention as described below in Example 8, the following information on previously know polymers is based on published literature values.

| | Dielectric | |
|---|---|---|
| Polymer | constant | Tangent loss |
| Poly vinyl butyrall | 3.33 | 0.024 |
| Poly(vinyl acetate) | 2.31 | 0.0037 |
| polyVDF | 7.6 | 0.015 |
| Poly | 2.05 | 0.003-0.004 |
| tetrafluoroethylene | | |
| (PTFE) | | |

### Example 8—Application Examples

Polymers were subjected to additional material characterization including melt flow index stud-ies, char tests, and determination of tangent loss and dielectric constant. Char tests were done using Dryusing Dry Ashing in Muffle Furnace technique Ref: 40378-21,23 or according to ASTM 5630. Melt flow index studies were determined using ASTM D1238.

Tabulated in Table 12 below are the results of char tests using and melt flow index studies that were conducted with the indicated monomers using procedures in accordance with Example 1:

TABLE 12

| | | Mole % HFO- | MFI (g/10 |
|---|---|---|---|
| Comonomer | Wt % Ash | 1234yf | minutes) |
| Vinyl butyrate | 0.35 | 94.2 | 1.67 at 190° C. |
| Vinyl butyrate | 0.05 | 82.5 | 5.84 at 90° C. |
| Vinyl butyrate | 0.10 | 69.2 | NA |
| Vinyl butyrate | 0.21 | 53.6 | 3.36 at 90° C. |
| Vinyl butyrate | 0.04 | 1.7 | 8.92 at 120°C. |
| Vinyl propionate | 0.04 | 94.2 | NA |
| Vinyl propionate | 0.05 | 61.6 | 0.81 at 100°C. |
| Vinyl propionate | 0.07 | 82.7 | 0.69 at 100°C. |
| Vinyl propionate | 0.02 | 42.8 | 2.73 at 120°C. |
| Vinyl propionate | 0.03 | 43 | 9.81-9.88 at 190° C |

Tangent loss and dielectric constant were determined from polymer films that were made using hot platens about 20-30° C. above Tg of the copolymer and are reported in Table 13 below. They were determined using ASTM D150-18 with GenRad 1689 Precision RLC Digibridge equipped with a disk-electrode parallel-plate capacitive cell.

TABLE 13

| | | | Mole % HFO- |
|---|---|---|---|
| | Dielectric | | 1234yf units in |
| Co-monomer | constant | Tangent loss | copolymer |
| Vinyl propionate | 1.92 | 0.0167 | 61.6 |
| Vinyl propionate | 1.99 | 0.0213 | 43 |
| Vinyl propionate | 2.15 | 0.0117 | 90.7 |
| Vinyl propionate | 2.06-2.21 | 0.0178-0.0164 | 43 |
| Vinyl propionate | 1.61 | 0.0083 | 43 |
| Vinyl butyrate | 1.75 | 0.0711 | 1.7 |
| Vinyl butyrate | 1.84 | 0.0253 | 1.7 |
| Vinyl chloride | 2.31 | 0.0117 | 11.8 |
| Vinyl chloride | 2.17 | 0.0113 | 11.8 |
| Vinyl chloride | 2.13 | 0.0096 | 11.8 |
| Vinyl chloride | 1.92 | 0.0082 | 32.5 |
| Vinyl chloride | 1.24 | 0.0243 | 32.5 |
| VDF | 1.87 | 0.0048 | 70-39 |
| VDF | 1.97 | 0.0059 | 70-39 |

As can be seen from the results above, the copolymers according to the present invention are able to provide excellent coatings on electronic and/or data transmission devices, such as wires and cable, namely, coating on such devices that provide highly desirable and unexpectedly low dielectric constants and loss tangent while at the same time providing good adhesion and good flexibility, among other desirable properties.

1. A fluorocopolymer formed by copolymerization of the monomers comprising (a) and (b):
(a) one or more hydrofluoroolefin represented by the formula I:
(CF₃)(R¹)C═C(R²)(R³)
wherein:
R¹ is selected from the group consisting of H, F, Cl and CF₃;
R² is selected from the group consisting of H, F, Cl and CF₃, and preferably is selected from H and F; and
R³ is selected from the group consisting of H and F; and
(b) one or more co-monomers selected from vinyl esters, one or more halogen-containing, non-cyclic C2-C6 olefin co-monomers different than monomer (a), and combinations of two or more of these.

2. The fluorocopolymer according to claim 1, wherein the hydrofluoroolefin is represented by the formula Ia:
(CF₃)(R^{1a})C═C(R^{2a})(R^{3a})
wherein:
R^{1a} is selected from the group consisting of H, F and CF₃;
R^{2a} is selected from the group consisting of H, F and CF₃, and preferably is selected from H and F; and
R^{3a} is selected from the group consisting of H and F.

3. The fluorocopolymer according to claim 1, wherein the hydrofluoroolefin is represented by the formula Ib:
(CF₃)(R^{1b})C═C(R^{2b})(R^{3b})
wherein:
R^{1b} is selected from the group consisting of H and F;
R^{2b} is selected from the group consisting of H and F; and
R^{3b} is H.

4. The fluorocopolymer according to claim 1, wherein the hydrofluoroolefin is represented by the formula Ic:
(CF₃)(R^{1c})C═C(R^{2c})(R^{3c})
wherein:
R^{1c} is selected from the group consisting of H, F and Cl;
R^{2c} is CF₃; and
R^{3c} is selected from the group consisting of H and F.

5. The fluorocopolymer according to claim 1, wherein the hydrofluoroolefin is represented by the formula Id:
(CF₃)(R^{1d})C═C(R^{2d})(R^{3d})
wherein:
R^{1d} is selected from the group consisting of H, F and Cl;
R^{2d} is selected from the group consisting of H, F and Cl; and
R^{3d} is H; wherein at least one of R^{1d} and R^{2d} is Cl.

6. The fluorocopolymer according to claim 1, wherein the hydrofluoroolefin is selected from the group consisting of 1234yf, 1234ze, 1233zd, 1233xf, 1336mzzm, 1336mcfq, 1225ye, 1225zc and 1224yd.

7. The fluorocopolymer according to any one of claims 1 to 6, wherein said vinyl ester monomer is present and has the formula II:
(R⁵)₂C═C(R⁶)(O—C═O—R⁷)
wherein each R⁵ is independently selected from H and methyl, R⁶ is selected from H and methyl, and R⁷ is selected from C₁ to C6 branched or straight-chain alkyl.

8. The fluorocopolymer according to any one of claims 1 to 7, wherein said vinyl ester monomer is present and has the formula IIa:
H₂C═CH—O—(C═O)—R⁸
wherein each R⁸ is selected from C₁ to C₆ branched or straight-chain alkyl.

9. The fluorocopolymer according to any one of claims 1 to 8, wherein said vinyl ester is present and is selected from the group consisting of vinyl acetate, vinyl propionate, vinyl butyrate, and vinyl iso-butyrate

10. The fluorocopolymer according to any one of claims 1 to 9, wherein the one or more halogen-containing, non-cyclic C2-C6 olefin co-monomers is present and is selected from the group consisting of vinyl fluoride (VF), vinylidene fluoride (VDF), trifluoroethylene (TrFE), tetrafluoroethylene (TFE), chlorotrifluoroethylene (CTFE), and mixtures thereof.

11. The fluorocopolymer according to any one of claims 1 to 10, wherein the one or more halogen-containing, non-cyclic C2-C6 olefin co-monomers is present and is according to the formula:
R¹R²C═CR¹R²
wherein R¹ and R² are each independently selected from Cl, H, or F, provided that at least one Cl or F is present on the molecule.
